(19) United States
(12) Patent Application Publication
(10) Pub. No.: US 2022/0009525 A1
(43) Pub. Date: Jan. 13, 2022

(54) INFORMATION PROCESSING DEVICE, MOBILE BODY, COMPUTER-READABLE RECORDING MEDIUM, AND METHOD

(71) Applicant: HONDA MOTOR CO.,LTD., Tokyo (JP)

(72) Inventors: Wataru AIKO, Tokyo (JP); Kazunori TOKUNAGA, Tokyo (JP); Mafuyu KOSEKI, Tokyo (JP); Takashi YAMADA, Tokyo (JP); Toshiaki TAKANO, Tokyo (JP); Satoshi ONODERA, Tokyo (JP)

(21) Appl. No.: 17/486,878

(22) Filed: Sep. 27, 2021

Related U.S. Application Data
(63) Continuation of application No. PCT/JP2019/014395, filed on Mar. 29, 2019.

(51) Int. Cl. B60W 60/00; G06Q 10/02

(52) U.S. Cl. CPC B60W 60/00253; G06Q 10/02

(57) ABSTRACT

Provided are a reservation information acquisition section of acquiring reservation information indicating a reservation condition for reservation of the first mobile object, an arrival determination section of determining whether the first mobile object can arrive at the position indicated by the reservation information by the time indicated by the reservation information, an arrangement section of determining to move the second mobile object different from the first mobile object to the position indicated by the reservation information in a case where it is determined that the first mobile object cannot arrive at the position indicated by the reservation information by the time indicated by the reservation information, and a consideration determination section of determining a condition regarding a consideration for the use of the second mobile object.

The contents of the following international application are incorporated herein by reference:

NO. PCT/JP2019/014395 filed in WO on Mar. 29, 2019.

### BACKGROUND

### 1. Technical Field

The present invention relates to an information processing apparatus, a mobile object, a computer-readable recording medium, and a method.

### 2. Related Art

An alternative vehicle guidance system that quickly guides a substitute vehicle to the position of a vehicle in which an abnormality has occurred is known (see, for example, Patent Document 1).

### PRIOR ART DOCUMENT

### Patent Document

Patent Document 1: Japanese Patent Application Publication No. 2000-172992

### BRIEF DESCRIPTION OF THE DRAWINGS

FIG. 1 schematically illustrates an example of a system configuration of a management system 100.

FIG. 2 schematically illustrates an example of vehicle dispatch by the management system 100.

FIG. 3 schematically illustrates an example of a system configuration of a management server 110.

FIG. 4 schematically illustrates an example of an internal configuration of a storage section 350.

FIG. 5 schematically illustrates an example of an internal configuration of a dispatch management section 360.

FIG. 6 schematically illustrates an example of an internal configuration of a substitute vehicle processing section 540.

FIG. 7 schematically illustrates an example of a screen 700.

FIG. 8 schematically illustrates an example of a screen 800.

FIG. 9 schematically illustrates an example of a screen 900.

FIG. 10 schematically illustrates an example of a screen 1000.

FIG. 11 schematically illustrates an example of a system configuration of a computer 3000.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to the solution of the invention. In the drawings, the same or similar parts are denoted by the same reference numerals, and redundant description may be omitted.

[Outline of Management System 100]

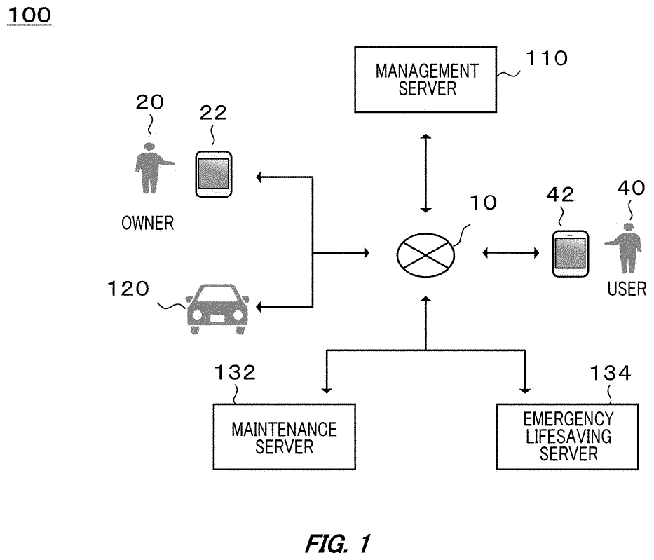

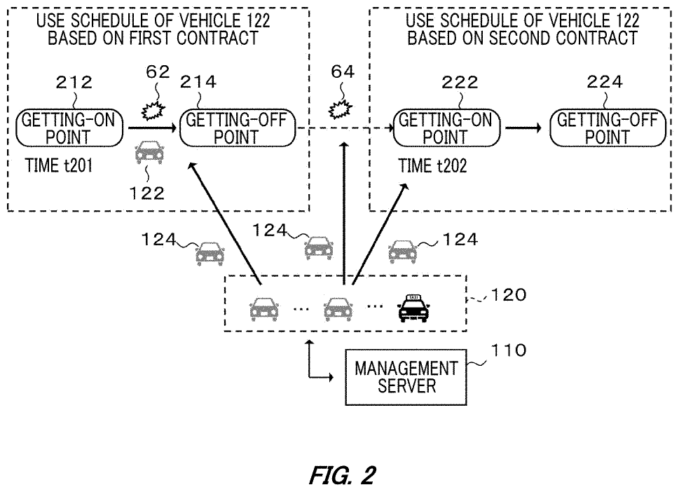

An outline of an example of the management system 100 will be described with reference to FIGS. 1 and 2. FIG. 1 schematically illustrates an example of a system configuration of the management system 100. FIG. 2 schematically illustrates an example of vehicle dispatch by the management system 100.

As illustrated in FIG. 1, in the present embodiment, the management system 100 includes a management server 110. The management system 100 may include one or plural (which may be omitted to one or more) vehicles 120. The management system 100 may include a communication terminal 22 used by owners 20 of one or more vehicles 120. The management system 100 may include a communication terminal 42 used by a user 40 who temporarily uses the vehicle 120. The management system 100 may include a maintenance server 132 for managing information regarding maintenance of at least one of the one or more vehicles 120. The management system 100 may include an emergency lifesaving server 134 for managing information regarding a rescue request. Each section of the management system 100 may transmit and receive information to and from each other via a communication network 10.

Note that the management system 100 may include one or more communication terminals 22 used by each of one or more owners 20. The management system 100 may include one or more communication terminals 42 used by each of one or more users 40. The management system 100 may include one or more maintenance servers 132. The management system 100 may include one or more emergency lifesaving servers 134.

In the present embodiment, the management system 100 manages the one or more vehicles 120. The management system 100 may manage the operation of each of the one or more vehicles 120. The management system 100 may manage a schedule of each of the one or more vehicles 120. The schedule of the vehicle 120 is specified by, for example, information indicating a time or a period and information indicating a schedule of the vehicle 120 at the time or the period. Examples of the schedule of the vehicle 120 include (i) waiting at a specific point or area, (ii) movement to a point designated by a dispatch request from the owner 20 or the user 40, (iii) use by the owner 20 or the user 40, and (iv) maintenance.

In one embodiment, the management system 100 manages a dispatch plan for each of the one or more vehicles 120. The dispatch plan may include information indicating the position of the next destination of each of the one or more vehicles 120. The dispatch plan may include information indicating one or more schedules regarding the movement of each of the one or more vehicles 120. Each piece of the information indicating one or more schedules may include information indicating a time or a period (also referred to as dispatch time) at which the vehicle 120 is dispatched and information indicating a position of a point (also referred to as a dispatch point) at which the vehicle 120 is dispatched. Each piece of the information indicating one or more schedules may include information indicating a duration of the schedule, an end time of the schedule, or predicted values of the duration and the end time. Each piece of the information indicating one or more schedules may include information indicating the position of the vehicle 120 at the end time of the schedule.

The management system 100 may manage the dispatch plan of each of the one or more vehicles 120 on the basis of a contract regarding use of the vehicle 120. The above contract may be a contract between an operator (not illustrated) of the management system 100 and the user 40, or may be a contract between the owner 20 and the user 40. The management system 100 may mediate the contract between the owner 20 and the user 40.

In one embodiment, the above contract is established in a case where the management system 100 accepts a request (also referred to as a dispatch request) from the user 40 who wishes to use the vehicle 120. In another embodiment, the above contract is established in a case where the management system 100 (i) processes the dispatch request and creates a dispatch plan corresponding to the dispatch request, and (ii) obtains approval of the dispatch plan from the user 40.

[Outline of Dispatch by Management System 100]

[Example of Arrangement of Vehicle 122]

As illustrated in FIG. 2, in the present embodiment, first, the management server 110 of the management system 100 acquires a first dispatch request from the user 40. The first dispatch request may include information indicating that it is requested to dispatch the vehicle 120 to a getting-on point 212 by time t201.

Upon acquiring the first dispatch request, the management server 110 allocates at least one of the one or more vehicles 120 under the management of the management server 110 in response to the first dispatch request. For example, the management server 110 allocates a specific vehicle 122 in response to the first dispatch request from the user 40.

As a result, for example, a first contract (also referred to as a first reservation) is established. The content of the first contract (also referred to as a reservation condition of the first reservation) may (i) specify that a person or an object is transported from the getting-on point 212 to the getting-off point 214 using the arbitrary vehicle 120 or the vehicle 120 meeting the specific condition, or (ii) specify that the arbitrary vehicle 120 or the vehicle 120 meeting the specific condition is dispatched at time t201 and the use of the vehicle 120 by the user 40 is permitted for a predetermined period thereafter. The end of the predetermined period may be a predetermined time or may be the time when the vehicle 120 arrives at the getting-off point 214.

Similarly, the management server 110 acquires a second dispatch request from the user 40. The second dispatch request may include information indicating that it is requested to dispatch the vehicle 120 to a getting-on point 222 by time t202. Time t202 may be a time after time t201. The user 40 who has transmitted the second dispatch request may be the same user 40 as the user 40 who has transmitted the first dispatch request, or may be a user 40 different from the user 40 who has transmitted the first dispatch request.

In a case where the management server 110 acquires the second dispatch request, the management server 110 allocates at least one of the one or more vehicles 120 under the management of the management server 110 in response to the second dispatch request. For example, the management server 110 allocates the vehicle 122 in response to the second dispatch request from user 40.

As a result, for example, a second contract (also referred to as a second reservation) is established. The content of the second contract (also referred to as a reservation condition of the second reservation) may (i) specify that a person or an object is transported from the getting-on point 222 to a getting-off point 224 using the arbitrary vehicle 120 or the vehicle 120 meeting the specific condition, or (ii) specify that the arbitrary vehicle 120 or the vehicle 120 meeting the specific condition is dispatched at time t202 and the use of the vehicle 120 by the user 40 is permitted for a predetermined period thereafter. The end of the predetermined period may be a predetermined time or may be the time when the vehicle 120 arrives at the getting-off point 224.

According to the present embodiment, the specific vehicle 122 is dispatched to the getting-on point 212 at time t201 based on the first contract, and is dispatched to the getting-on point 222 at time t202 based on the second contract. Here, it is also conceivable that an accident 62 occurs while the vehicle 122 moves from the getting-on point 212 to the getting-off point 214, and the movement of the vehicle 122 is restricted. In addition, it is also conceivable that an accident 64 occurs while the vehicle 122 in an empty state moves from the getting-off point 214 to the getting-on point 222, and the movement of the vehicle 122 is restricted.

The accident may be an event that interferes with the operation of the vehicle 122. Examples of the accident that causes the restriction on the movement of the vehicle 122 include at least one of (i) a failure of the vehicle 122, (ii) an accident involving the vehicle 122, and (iii) an event that restricts at least one of the moving speed and the moving route of the vehicle 122. Examples of the event of limiting at least one of the moving speed and the moving route of the vehicle 122 include at least one of an accident on a route on which the vehicle 122 has been scheduled to move, a traffic jam on the route, and a traffic restriction on a partial route on the route.

[One Example of Arrangement of Substitute Vehicle 124]

In this case, depending on the degree of restriction on the movement of the vehicle 122, there is a possibility that the vehicle 122 cannot arrive at the getting-on point 222 by time t202. As a result, there is a possibility that the vehicle 122 cannot perform the second contract during the performance period of the second contract.

Therefore, according to the present embodiment, in a case where a predetermined condition (also referred to as a condition regarding arrangement of a substitute vehicle) is satisfied, the management server 110 determines to dispatch the substitute vehicle 124 to the getting-on point 222. The management server 110 may determine to dispatch a plurality of substitute vehicles 124 to the occurrence point. The management server 110 may determine to dispatch the same number of substitute vehicles 124 as the number of vehicles 122 to the occurrence point. In addition, the management server 110 may execute processing for dispatching the substitute vehicle 124 to the getting-on point 222.

In this case, the user 40 who has requested the use of the vehicle 120 by the second dispatch request uses the substitute vehicle 124 as the vehicle 120 corresponding to the second dispatch request. However, depending on the content of the second dispatch request, regardless of whether the vehicle 122 or the substitute vehicle 124 is assigned as the vehicle 120 corresponding to the second dispatch request, the user experience of the user 40 is not affected.

In one embodiment, the management server 110 determines whether the vehicle 122 can perform the second contract. Then, in a case where it is determined that the performance of the second contract by the vehicle 122 allocated to the second contract at the time of the contract of the second contract is impossible, the management server 110 determines to dispatch the substitute vehicle 124 to the getting-on point 222.

In another embodiment, the management server 110 determines whether the vehicle 122 can arrive at the getting-on point 222 by time t202. In a case where it is determined that the vehicle 122 cannot arrive at the getting-on point 222 by time t202, the management server 110 determines to dispatch the substitute vehicle 124 to the getting-on point 222.

[Another Example of Arrangement of Substitute Vehicle 124]

Further, depending on at least one of the content of the accident 62 or the accident 64, the position of the occurrence point, and the occurrence time, the substitute vehicle 124 is dispatched to the occurrence point of the accident 62 or the accident 64, whereby the user experience of the user 40 may be greatly improved. For example, in a case where it is difficult to move the vehicle 122 due to an accident or a failure, the substitute vehicle 124 is arranged for the user 40, so that the user experience of the user 40 is greatly improved.

In a case where the accident 62 or the accident 64 occurs in an area where the operation frequency of the public transportation is low or an area where the transportation service by the public transportation is not provided, the substitute vehicle 124 is arranged for the user 40, so that the user experience of the user 40 is greatly improved. Further, in a case where the accident 62 or the accident 64 occurs in a time zone in which the operation frequency of the public transportation is low or a time zone outside the business hours of the public transportation, the substitute vehicle 124 is arranged for the user 40, so that the user experience of the user 40 is greatly improved. Examples of the public transportation include a bus, a taxi, and a railway.

Therefore, according to the present embodiment, in a case where a predetermined condition (also referred to as a condition regarding arrangement of a substitute vehicle) is satisfied, the management server 110 determines to dispatch the substitute vehicle 124 to, for example, the occurrence point of an accident. The management server 110 may determine to dispatch the plurality of substitute vehicles 124 to the occurrence point of the accident. The occurrence point of the accident may be a position of the vehicle 122 in a period in which the accident continues in the vehicle 122, and may have a certain range. The management server 110 may determine to dispatch a larger number of the substitute vehicles 124 than the number of the vehicles 122 to the occurrence point. In addition, the management server 110 may execute processing for dispatching the substitute vehicle 124 to the occurrence point.

In one embodiment, the management server 110 determines the occurrence of an accident. Specifically, the management server 110 determines whether at least one of a failure and an accident has occurred in the vehicle 122, or whether a probability of occurrence of at least one of a failure and an accident in the vehicle 122 is large. The management server 110 may determine whether a probability of occurrence of at least one of a failure and an accident in the vehicle 122 is larger than a predetermined criterion. In a case where it is determined that at least one of a failure and an accident has occurred in the vehicle 122, or a case where it is determined that the probability of occurrence of at least one of a failure and an accident in the vehicle 122 is high, the management server 110 determines to dispatch the substitute vehicle 124 to the occurrence point.

In another embodiment, the management server 110 determines whether the movement of the vehicle 122 is restricted. In a case where it is determined that the movement of the vehicle 122 is restricted, the management server 110 determines to dispatch the substitute vehicle 124 to the occurrence point.

As described above, according to the present embodiment, for example, even in a case where an accident occurs regarding a specific vehicle 122, the substitute vehicle 124 can be arranged. As a result, the user experience of the user 40 is greatly improved. In addition, as a technical effect, since the substitute vehicle 124 can be arranged before the performance period of the second contract arrives, the dispatch plan can be efficiently created. For example, the amount of sudden interrupt handling in the management system 100 can be reduced, and the computer resources of the management system 100 can be efficiently utilized.

[Outline of Each Section of Management System 100]

In the present embodiment, the communication network 10 transmits information between each section of the management system 100. The communication network 10 may be a transmission path for wired communication, a transmission path for wireless communication, or a combination thereof. The communication network 10 may include a wireless packet communication network, the Internet, a P2P network, a dedicated line, a VPN, a power line communication line, and the like. The communication network 10 may include (i) a mobile communication network such as a mobile telephone network, and (ii) a wireless data communication network such as a wireless metropolitan area network (MAN) (for example, WiMAX (registered trademark)), a wireless local area network (LAN) (for example, WiFi (registered trademark)), Bluetooth (registered trademark), Zigbee (registered trademark), or Near Field Communication (NFC).

In the present embodiment, the owner 20 transports a person or an object to a specific point (also referred to as a destination) using, for example, the vehicle 120. The owner 20 may use the vehicle 120 to transport the owner 20 himself or herself, or may use the vehicle 120 to transport a person other than the owner 20 (also referred to as a party of the owner 20) or an object. The object transported by the vehicle 120 may be a baggage of the owner 20 or a baggage of a party of the owner 20.

The owner 20 may transport a person or an object to a destination by using the vehicle 120 on the basis of the contract. In this case, the owner 20 may drive the vehicle 120 by himself or herself, may command a person under the direction of the owner 20 to drive the vehicle 120, or may entrust a third party to drive the vehicle 120.

The owner 20 may temporarily cause another person to use the vehicle 120. The owner 20 may cause another person to use the vehicle 120 on the basis of the contract. For example, the owner 20 lends the vehicle 120 to another person. The owner 20 may cause the user 40 who wishes to use the vehicle 120 to use the vehicle 120 through mediation of the management server 110.

The owner 20 may be the possessor of the vehicle 120, may be a person who has the right to make a profit from using the vehicle 120, or may be a person who has the right to grant another person the right to use the vehicle 120. The owner 20 may be a person who uses the vehicle 120 on the basis of a lease agreement. The owner 20 may be an individual, a corporation, or an association.

The owner 20 may at least temporarily use the vehicle 120 for taxi or cab applications. The owner 20 may at least temporarily use the vehicle 120 for car rental, car sharing, or ride-sharing applications.

In the present embodiment, the communication terminal 22 is, for example, a communication terminal used by the owner 20. The communication terminal 22 may be a communication terminal used by a person who uses the vehicle 120 for the owner 20. Examples of the person who uses the vehicle 120 for the owner 20 include a family member, a relative, an employee, a member, a person who has been entrusted with any work performed using the vehicle 120 (may be an individual, a corporation, or an association), and a family member, a relative, an employee, a member, and the like of the person who has been entrusted with the work.

In the present embodiment, the communication terminal 22 transmits and receives various types of information to and from each section of the management system 100 via the communication network 10. The communication terminal 22 may include an input device and an output device, and may be used as a user interface of the management system 100.

The communication terminal 22 only needs to be any information processing apparatus having a communication function, and details thereof are not particularly limited. Examples of the communication terminal 22 include a personal computer and a mobile terminal. Examples of the mobile terminal include a mobile phone, a smartphone, a PDA, a tablet, a notebook computer or a laptop computer, a wearable computer, and the like.

In the present embodiment, the user 40 temporarily uses the vehicle 120. The user 40 may acquire the right to temporarily use the vehicle 120 on the basis of the contract. The above contract may be mediated by the management server 110. The user 40 may acquire the information regarding the contract from the management server 110 using the communication terminal 42. The user 40 may be an individual, a corporation, or an association.

In one embodiment, the user 40 transports a person or object to a destination using the vehicle 120, for example, on the basis of a transportation agreement with the owner 20. In other embodiments, the user 40 transports a person or object to a destination using the vehicle 120, for example, on the basis of a rental agreement with the owner 20. The person transported by the vehicle 120 may be the user 40 or a person other than the user 40 (also referred to as a party of the user 40). The object transported by the vehicle 120 may be a baggage of the user 40 or a baggage of a party of the user 40.

In the present embodiment, the communication terminal 42 is, for example, a communication terminal used by the user 40. The communication terminal 42 may be a communication terminal used by a person who uses the vehicle 120 for the user 40. Examples of the person who uses the vehicle 120 for the user 40 include a family member, a relative, an employee, a member, a person who has been entrusted with any work performed using the vehicle 120 (may be an individual, a corporation, or an association), and a family member, a relative, an employee, a member, and the like of the person who has been entrusted with the work.

In the present embodiment, the communication terminal 42 transmits and receives various types of information to and from each section of the management system 100 via the communication network 10. The communication terminal 42 includes an input device and an output device, and may be used as a user interface of the management system 100.

The communication terminal 42 may be any information processing apparatus having a communication function, and details thereof are not particularly limited. Examples of the communication terminal 42 include a personal computer and a mobile terminal. Examples of the mobile terminal include a mobile phone, a smartphone, a PDA, a tablet, a notebook computer or a laptop computer, a wearable computer, and the like.

In the present embodiment, the management server 110 manages the one or more vehicles 120. The management server 110 may manage the operation of each of the one or more vehicles 120. The management server 110 may manage a schedule of each of the one or more vehicles 120. The management server 110 may manage the dispatch of each of the one or more vehicles 120.

In the present embodiment, the management server 110 manages one or more contracts regarding use of at least one of the one or more vehicles 120. The management server 110 may manage the performance of each of the one or more contracts described above. The management server 110 may manage the performance status of the contract by the vehicle 122 allocated to each contract. In a case where it is difficult for the vehicle 122 allocated to each contract to perform the contract, the management server 110 may arrange the substitute vehicle 124.

The management server 110 may manage a consideration for the use of at least one of the one or more vehicles 120. For example, the management server 110 manages a consideration for the use of the vehicle 122. The management server 110 may manage a consideration for the use of the substitute vehicle 124. More specifically, the management server 110 may determine the amount of consideration or may determine the payment method of the consideration.

In the present embodiment, the vehicle 120 is used, for example, by the user 40 to transport a person or an object. The vehicle 120 may be used for transporting the user 40 or a party of the user 40, or may be used for transporting a package of the user 40 or a party of the user 40. Note that the owner 20 may use the vehicle 120 as the user 40.

In one embodiment, the vehicle 120 is used by the user 40, for example, on the basis of a contract between the owner 20 and the user 40. In another embodiment, the vehicle 120 is used by the user 40, for example, on the basis of a contract between the operator of the management server 110 and the user 40.

For example, the vehicle 120 departs from a point according to a request of the user 40 and transports a person or an object to a point according to a request of the user 40. The vehicle 120 may return to the departure point after transporting a person or an object to a point according to the request of the user 40, or may move to a point different from the departure point. The vehicle 120 may move, in accordance with an instruction (also referred to as a dispatch instruction) from the management server 110, to the point designated by the dispatch instruction.

The vehicle 120 may be an unmanned driving vehicle or an automatic driving vehicle, or may be a manned driving vehicle. Examples of the vehicle 120 include a bicycle, an automobile, a motorcycle, and a train. Examples of the automobile include an engine vehicle, an electric vehicle, a fuel cell vehicle, a hybrid vehicle, and a work machine. Examples of the motorcycle include (i) a motorcycle, (ii) a three-wheeled bicycle, and (iii) a standing-riding two-wheeled bicycle or three-wheeled bicycle having a power unit.

In the present embodiment, the maintenance server 132 may be a communication terminal used by a maintenance company (not illustrated) that performs maintenance of at least one of the one or more vehicles 120. The maintenance server 132 manages, for example, information regarding maintenance of at least one of the one or more vehicles 120.

Examples of the maintenance of the vehicle 120 include at least one of (i) cleaning of the vehicle 120, (ii) inspection of the vehicle 120, (iii) maintenance or repair of the vehicle 120, and (iv) replenishment of energy or an energy source to the vehicle 120. Examples of the cleaning include cleaning of the vehicle interior and cleaning of the vehicle exterior. Examples of maintenance or repair of the vehicle 120 include (i) fixing, adjustment, or replacement of parts or consumables, and (ii) replenishment of consumables. Examples of the energy or energy source include electricity, gasoline, light oil, alcohol, natural gas, propane gas, and hydrogen.

In the present embodiment, the maintenance server 132 only needs to be an information processing apparatus capable of transmitting and receiving various types of information to and from each section of the management system 100 via the communication network 10, and details thereof are not particularly limited. Examples of the maintenance server 132 include a personal computer and a mobile terminal. Examples of the mobile terminal include a mobile phone, a smartphone, a PDA, a tablet, a notebook computer or a laptop computer, a wearable computer, and the like.

In the present embodiment, the emergency lifesaving server 134 may be a communication terminal used by at least one of (i) an administrative agency, (ii) an emergency lifesaving institution such as a hospital or a fire department, and (iii) a security institution such as a police department or a private security company. The emergency lifesaving server 134 manages, for example, information regarding the rescue request.

The emergency lifesaving server 134 receives, for example, a rescue request from at least one of the one or more vehicles 120. The emergency lifesaving server 134 receives, for example, a rescue request from at least one user 40 of the one or more vehicles 120. The emergency lifesaving server 134 may store information regarding the rescue request in an appropriate storage apparatus. Examples of the information regarding the rescue request include information regarding a person in need of rescue, information regarding necessity of dispatch of a rescue vehicle, and information indicating a destination of the rescue vehicle.

In the present embodiment, the emergency lifesaving server 134 only needs to be an information processing apparatus capable of transmitting and receiving various types of information to and from each section of the management system 100 via the communication network 10, and details thereof are not particularly limited. Examples of the emergency lifesaving server 134 include a personal computer and a mobile terminal. Examples of the mobile terminal include a mobile phone, a smartphone, a PDA, a tablet, a notebook computer or a laptop computer, a wearable computer, and the like.

[Specific Configuration of Each Section of Management System 100]

Each section of the management system 100 may be implemented by hardware, software, or hardware and software. At least a part of each section of the management system 100 may be realized by a single server or may be realized by a plurality of servers. At least a part of each section of the management system 100 may be realized on a virtual server or a cloud system. At least a part of each section of the management system 100 may be realized by a personal computer or a mobile terminal. Examples of the mobile terminal may include a mobile phone, a smartphone, a PDA, a tablet, a notebook computer or a laptop computer, a wearable computer, and the like. Each section of the management system 100 may store information by using a distributed ledger technology such as a blockchain or a distributed network.

In a case where at least some of the components constituting the management system 100 are realized by software, the components realized by the software may be realized by starting a program defining an operation regarding the components in an information processing apparatus having a general configuration. The information processing apparatus having the above general configuration may include (i) a data processing apparatus including a processor such as a CPU and a GPU, a ROM, a RAM, a communication interface, and the like, (ii) an input apparatus such as a keyboard, a pointing device, a touch panel, a camera, a voice input apparatus, a gesture input apparatus, various sensors, or a GPS receiver, (iii) an output apparatus such as a display apparatus, a voice output apparatus, or a vibration apparatus, and (iv) a storage apparatus (including an external storage apparatus) such as a memory, an HDD, or an SSD.

In the information processing apparatus having the above general configuration, the above data processing apparatus or storage apparatus may store the above program. The program is executed by the processor to cause the information processing apparatus to execute an operation defined by the program. The above program may be stored in a non-transitory computer-readable recording medium. The above program may be stored in a computer-readable medium such as a CD-ROM, a DVD-ROM, a memory, or a hard disk, or may be stored in a storage apparatus connected to a network.

The above program may be a program for causing a computer to function as the management system 100 or a part thereof. The above program may include a module that defines the operation of each section of the management system 100. These programs or modules work on a data processing apparatus, an input apparatus, an output apparatus, a storage apparatus, and the like to cause a computer to function as each section of the management system 100 or cause the computer to execute an information processing method in each section of the management system 100.

The above program may be installed in a computer constituting at least a part of the management system 100 from a computer-readable medium or a storage apparatus connected to a network. By executing the above program, the computer may function as at least a part of each section of the management system 100. The information processing described in the above program functions as a specific means in which software related to the program and various hardware resources of the management system 100 or a part of the management system 100 cooperate by the program being read by the computer. Then, the management system 100 according to the purpose of use is constructed by the specific means described above realizing calculation or processing of information according to the purpose of use of the computer in the present embodiment.

The above program may be a program for causing a computer to function as the management server 110. The above program may be a program for causing a computer to execute the information processing method in the management server 110. The above program may be a program for causing a computer to function as a control apparatus of the vehicle 120. The above program may be a program for causing a computer to execute the information processing method in the control apparatus of the vehicle 120.

The above method may have an accident determination step of determining that an operation trouble state has occurred in a first mobile object, an arrangement step of determining to move one or more third mobile objects different from the first mobile object to the position where the operation trouble state has occurred in a case where it is determined that the operation trouble state has occurred, and a consideration determination step of determining a condition regarding a consideration for the use of the one or more third mobile objects. Each step of the above method may be executed by a computer.

The above method may include a mobile object information acquisition step of acquiring information indicating at least one of the position and the state of the first mobile object allocated in response to a use request, a limitation determination step of determining whether the movement of the first mobile object is limited on the basis of the information acquired in the mobile object information acquisition step, an arrangement step of arranging the third mobile object different from the first mobile object in a case where it is determined that the movement of the first mobile object is limited, and a condition information acquisition step of acquiring information indicating a condition requested by the user of the first mobile object to the third mobile object. The arrangement step may include a step of determining the third mobile object on the basis of the information acquired in the condition information acquisition step. Each step of the above method may be executed by a computer.

The above method may be a method for managing reservations and the reservation conditions of the reservation of a mobile object. The above method may include: a first determination step of determining to allocate the first mobile object to perform a reservation; a performance determination step of determining, after the determination in the first determination step and before a reservation time indicated by the reservation condition, whether the first mobile object can perform the reservation; a second determination step of determining to allocate a second mobile object different from the first mobile object to perform the reservation in a case where it is determined that the first mobile object cannot perform the reservation in the performance determination step; and an adjustment step of adjusting the content of at least one of claims and liabilities between the reserving parties in a case where some of the reservation conditions are not performed by the determination in the second determination step. Each step of the above method may be executed by a computer.

The above method may include a reservation information acquisition step of acquiring reservation information indicating a reservation condition for reservation of the first mobile object, an arrival determination step of determining whether the first mobile object can arrive at the position indicated by the reservation information by the time indicated by the reservation information, an arrangement step of determining to move the second mobile object different from the first mobile object to the position indicated by the reservation information in a case where it is determined that the first mobile object cannot arrive at the position indicated by the reservation information by the time indicated by the reservation information, and a consideration determination step of determining a condition regarding a consideration for the use of the second mobile object. Each step of the above method may be executed by a computer.

The management system 100 may be an example of an information processing apparatus. The management server 110 may be an example of the information processing apparatus. The vehicle 120 may be an example of a mobile object. The vehicle 120 may be an example of the first mobile object, the second mobile object, and the third mobile object. The vehicle 122 may be an example of the first mobile object. The substitute vehicle 124 may be an example of the second mobile object and the third mobile object.

The first dispatch request may be an example of the use request. The first dispatch request may be an example of the reservation information. The first dispatch request may be an example of the first reservation. The first reservation may be an example of the reservation. The content of the first reservation may be an example of the reservation condition. The second dispatch request may be an example of the use request. The second dispatch request may be an example of the reservation information. The second dispatch request may be an example of the second reservation. The second reservation may be an example of the reservation. The content of the second reservation may be an example of the reservation condition.

Time t201 may be an example of the performance period of the first contract. Time t201 may be an example of the time indicated by the contract information indicating the content of the first contract. The getting-on point 212 may be an example of a position indicated by the contract information indicating the content of the first contract. Time t202 may be an example of the performance period of the second contract. Time t202 may be an example of the time indicated by the contract information indicating the content of the second contract. The getting-on point 212 may be an example of a position indicated by the contract information indicating the content of the second contract.

The user 40 of the second contract may be an example of an applicant of the contract. The user 40 of the second contract may be an example of a user of the vehicle 120. The party of the user 40 of the second contract may be an example of the user of the vehicle 120.

The occurrence of the accident 62 may be an example of the occurrence of the operation trouble state. The occurrence of the accident 64 may be an example of the occurrence of the operation trouble state. Whether at least one of the failure and the accident has occurred in the vehicle 122 indicates an example of the presence or absence of the occurrence of the operation trouble state. Whether the probability of occurrence of at least one of the failure and the accident in the vehicle 122 is large indicates an example of the presence or absence of the occurrence of the operation trouble state.

Note that, in the present embodiment, an example of the management system 100 will be described by taking a case where the management server 110 executes information processing for managing the vehicle 120 or a contract regarding the vehicle 120 as an example. In the present embodiment, the management server 110 manages the operation of the vehicle 120 via the communication network 10 including a wireless communication network. However, the management system 100 is not limited to the present embodiment. In another embodiment, the information processing apparatus mounted on the vehicle 120 may execute at least part of the information processing in the management server 110 according to the present embodiment. In this case, the information processing apparatus mounted on the vehicle 120 may be an example of the information processing apparatus.

Further, in the present embodiment, an example of the management system 100 will be described by taking a case where the vehicle 120 is used to transport the transportation target to a destination as an example. However, the management system 100 is not limited to the present embodiment. In another embodiment, an arbitrary mobile object may be used to transport the transportation target to the destination.

Examples of the mobile object include a vehicle, a vessel, and a flying object. Examples of the vehicle include a bicycle, an automobile, a motorcycle, and a train. Examples of the vessel include a ship, a hovercraft, a water bike, a submarine, a submersible, and an underwater scooter. Examples of the flying object include an airplane, an airship, or a balloon, a balloon, a helicopter, and a drone.

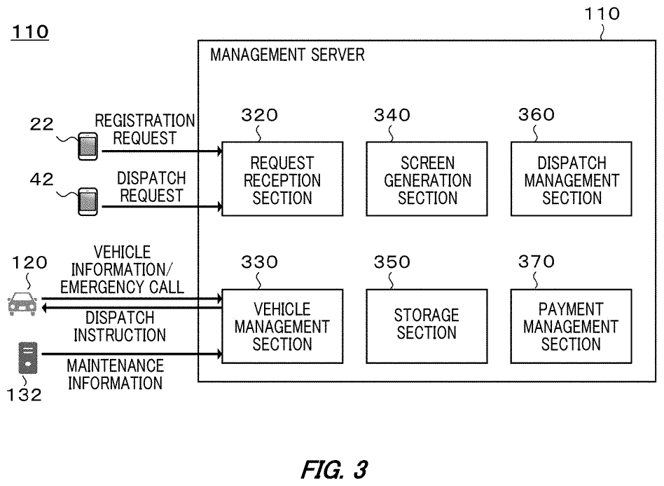

FIG. 3 schematically illustrates an example of a system configuration of the management server 110. In the present embodiment, the management server 110 includes, for example, a request reception section 320, a vehicle management section 330, a screen generation section 340, and a storage section 350. In the present embodiment, the management server 110 includes, for example, a dispatch management section 360. In the present embodiment, the management server 110 includes, for example, a payment management section 370.

In the present embodiment, the request reception section 320 accepts various requests from at least one of the owner 20 and the user 40. In one embodiment, the request reception section 320 accepts a registration request from the owner 20. In another embodiment, the request reception section 320 accepts a dispatch request from the user 40. As a result, the request reception section 320 can acquire information (also referred to as contract information) indicating the content of the contract regarding the use of the vehicle 120.

In the present embodiment, the vehicle management section 330 manages one or more vehicles 120. In one embodiment, the vehicle management section 330 manages the position of each of the one or more vehicles 120. For example, the vehicle management section 330 manages the position of each of the one or more vehicles 120 by transmitting a dispatch instruction, a standby instruction, or a return instruction to each of the one or more vehicles 120.

The dispatch instruction may be an instruction for instructing the vehicle 120 or the driver of the vehicle 120 to move to a specific position. The dispatch instruction may be an instruction for instructing the vehicle 120 or the driver of the vehicle 120 to move to a specific position by a specific time.

The standby instruction may be an instruction for instructing the vehicle 120 or the driver of the vehicle 120 to stand by in a specific position or area. The standby instruction may be an instruction for instructing the vehicle 120 or the driver of the vehicle 120 to stand by in a specific position or area until a specific condition is satisfied. Examples of the specific condition include a condition that a specific time has come, a condition that a remaining amount of energy or an energy source does not satisfy a specific criterion, and the like.

The return instruction may be an instruction for instructing the vehicle 120 or the driver of the vehicle 120 to move to a predetermined return location. The return instruction may be an instruction for instructing the vehicle 120 or the driver of the vehicle 120 to move to a predetermined return location by a specific time.

The vehicle management section 330 may acquire information indicating the current position or the movement history of each of the one or more vehicles 120 from each of the one or more vehicles 120. The information indicating the current position may be information in which identification information of the vehicle 120, information indicating time, and information indicating the position of the vehicle 120 at the time are associated with each other. The information indicating the movement history may be information including the identification information of the vehicle 120 and a plurality of records regarding the position of the vehicle 120. Each record regarding the position of the vehicle 120 may be information in which information indicating time is associated with information indicating the position of the vehicle 120 at the time.

In another embodiment, the vehicle management section 330 manages the state of each of the one or more vehicles 120. For example, the vehicle management section 330 acquires information indicating the state of each of the one or more vehicles 120 from each of the one or more vehicles 120. The vehicle management section 330 may acquire the information in which the information indicating time is associated with the information indicating the state of the vehicle 120 at the time from each of the one or more vehicles 120.

Examples of the information indicating the state of the vehicle 120 include at least one of information regarding a driving mode of the vehicle 120, information regarding a speed of the vehicle 120, information regarding a driving operation of the vehicle 120, information regarding an operation status of a driving assistance apparatus mounted on the vehicle 120, information acquired by a vehicle exterior imaging apparatus mounted on the vehicle 120, and information regarding an emergency call from the vehicle 120 or a passenger of the vehicle 120. Examples of the information regarding the driving mode of the vehicle 120 include information indicating whether the vehicle 120 is in a manual driving mode, whether the vehicle 120 is in an automatic driving mode, and the like. Examples of the information regarding the speed of the vehicle 120 include information indicating the speed of the vehicle 120, the acceleration of the vehicle 120, the angular speed of the vehicle 120, the angular acceleration of the vehicle 120, and the like. Examples of the information regarding the driving operation of the vehicle 120 include information indicating a situation of an operation input by the driver of the vehicle 120, a situation inside the vehicle 120, and the like. Examples of the information on the operation status of the driving assistance apparatus mounted on the vehicle 120 include an operation status of an advanced driving assistance system, an operation status of a collision avoidance system, an operation status of an automatic brake system, an operation status of an automatic steering system, an operation status of an air bag, and the like. Examples of the information acquired by the vehicle exterior imaging apparatus mounted on the vehicle 120 include recorded data of a drive recorder mounted on the vehicle 120. Examples of the information regarding the emergency call from the vehicle 120 or the passenger of the vehicle 120 include information indicating the presence or absence of an emergency call, the presence or absence of a rescue request, the presence or absence of the activation of an air bag, and the like.

Examples of the situation inside the vehicle 120 include image data of an image captured by an in-vehicle camera mounted on the vehicle 120, analysis data of the image, and the like. The situation inside the vehicle 120 may be voice data of a voice recorded by an in-vehicle microphone mounted on the vehicle 120 or analysis data of the voice. Examples of the situation outside the vehicle 120 include image data of an image captured by an vehicle exterior camera mounted on the vehicle 120, analysis data of the image, and the like. The situation outside the vehicle of the vehicle 120 may be voice data of a voice recorded by a vehicle exterior microphone mounted on the vehicle 120 or analysis data of the voice.

In the present embodiment, the screen generation section 340 generates various screens that can be used as a user interface between the management server 110 and at least one of the owner 20 and the user 40. Examples of the screen include a vehicle registration screen, a dispatch request screen, a dispatch confirmation screen, and a change notification screen.

The vehicle registration screen is used, for example, in a registration process for the owner 20 to register the own vehicle 120 as the vehicle 120 usable by the user 40 in the management server 110. The management server 110 may accept a registration request from the owner 20 via the vehicle registration screen. Details of the vehicle registration screen will be described later.

The dispatch request screen is used, for example, in a dispatch request process for the user 40 to request the management server 110 to dispatch the vehicle 120. The management server 110 may accept the dispatch request from the user 40 via the dispatch request screen. Details of the dispatch request screen will be described later.

For example, the dispatch confirmation screen is used in a dispatch confirmation process in order that the management server 110 presents the content of the contract established on the basis of the dispatch request from the user 40 to the user 40. Details of the dispatch confirmation screen will be described later.

The change notification screen is used in a change notification process in which the management server 110 presents the content of a change to the user 40 in a case where the contract content with the user 40 is changed according to the arrangement of the substitute vehicle 124 by the management server 110. Details of the change notification screen will be described later.

In the present embodiment, the storage section 350 stores various types of information. The storage section 350 may store information used in the information processing of the management server 110. The storage section 350 may store information generated in the information processing of the management server 110. Details of the storage section 350 will be described later.

In the present embodiment, the dispatch management section 360 manages the dispatch of the vehicle 120. At least one dispatch of the one or more vehicles 120 may be managed. In one embodiment, the dispatch management section 360 acquires a dispatch request from the user 40, and allocates the specific vehicle 122 in response to the dispatch request. The dispatch management section 360 manages the operation of the vehicle 122 so that the vehicle 122 arrives at the position indicated in the dispatch request by the time indicated in the dispatch request.

In another embodiment, the dispatch management section 360 monitors at least one of a position and a state of the vehicle 122. For example, in a case where at least one of the position and the state of the vehicle 122 satisfies the condition regarding the arrangement of a substitute vehicle, the dispatch management section 360 arranges one or more substitute vehicles 124. Details of the dispatch management section 360 will be described later.

In the present embodiment, the payment management section 370 manages payment regarding a consideration for the use of the vehicle 120. In one embodiment, the payment management section 370 executes processing for paying a consideration for the use of the vehicle 122. In another embodiment, the payment management section 370 executes processing for paying a consideration for the use of the substitute vehicle 124.

The request reception section 320 may be an example of a contract information acquisition section. The request reception section 320 may be an example of a use request acquisition section. The vehicle management section 330 may be an example of a mobile object information acquisition section, and the dispatch management section 360 may be an example of the information processing apparatus.

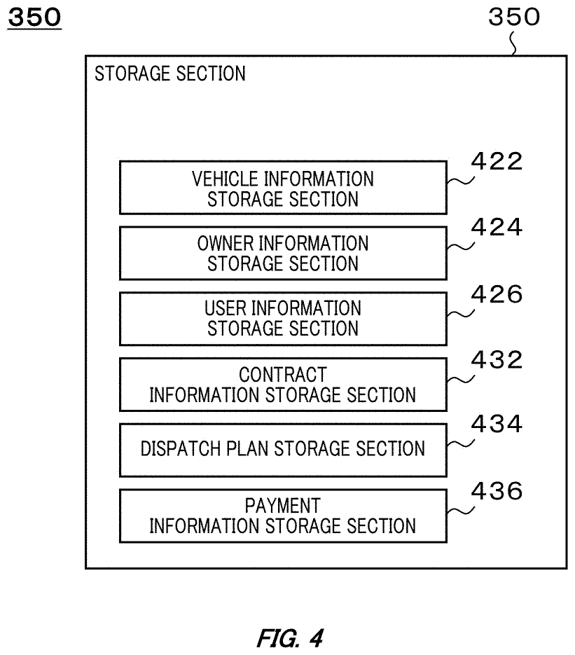

FIG. 4 schematically illustrates an example of an internal configuration of the storage section 350. In the present embodiment, the storage section 350 includes, for example, a vehicle information storage section 422, an owner information storage section 424, a user information storage section 426, a contract information storage section 432, a dispatch plan storage section 434, and a payment information storage section 436.

In the present embodiment, the vehicle information storage section 422 stores various types of information (also referred to as vehicle information) regarding each of the one or more vehicles 120. For each of the one or more vehicles 120, the vehicle information storage section 422 may store identification information of the vehicle and vehicle information of the vehicle in association with each other. Examples of the vehicle information include information indicating the position of the vehicle 120, information indicating the state of the vehicle 120, and information indicating the attribute of the vehicle 120.

The attribute of the vehicle 120 may include a condition regarding a use application or a use method of the vehicle 120. More specifically, examples of the attribute of the vehicle 120 include at least one of a type of the vehicle 120, a capacity of the vehicle 120, a specification of a living space of the vehicle 120, a maximum loading capacity of the vehicle 120, a specification of a cargo storage space of the vehicle 120, a type of equipment mounted on the vehicle 120, a specification of equipment mounted on the vehicle 120, an attribute of an object mountable on the vehicle 120, whether smoking in the vehicle 120 is permitted, and a cleaning state of the vehicle 120. Examples of the type of the vehicle 120 include a vehicle type or a type, a manufacturer name or a seller name, a model name or a title, and a manufacturing year. Examples of the vehicle type or the type include a SUV, a sedan, and a motorcycle. Examples of the specification of the various spaces include a capacity of the space, a dimension of the space, and the like.

Examples of the equipment mounted on the vehicle 120 include an audio device, a video device, an air conditioning device, an advanced driving assistance system, a collision avoidance system, an automatic brake system, an automatic steering system, an air bag, and the like. Examples of the attribute of an object mountable in the vehicle 120 include whether a pet can board, whether an infant can board, whether a child or an infant under a specific age can board, whether a smoker can board, and whether an object emitting an odor at a specific odor level or higher can be mounted.

In the present embodiment, the owner information storage section 424 stores various types of information regarding each of one or more owners 20. The owner information storage section 424 stores, for each of one or more owners 20, identification information of the owner and information on the owner in association with each other. Examples of the information regarding the owner 20 include information regarding a name or a title, an address, an account for payment, an account for communication, and the like.

In the present embodiment, the user information storage section 426 stores various types of information regarding each of one or more users 40. The user information storage section 426 stores, for each of one or more users 40, identification information of the user and information regarding the user in association with each other. Examples of the information regarding the user 40 include information regarding a name or a title, an address, an account for payment, an account for communication, and the like.

In the present embodiment, the contract information storage section 432 stores information (also referred to as contract information) regarding each of one or more contracts. The contract information storage section 432 may store identification information of each contract and information indicating the content of each contract in association with each other. The identification information of the contract may be identification information of a dispatch request corresponding to the contract. Examples of the information indicating the content of the contract include information indicating at least one of the contracting parties (for example, the user 40), information indicating a condition regarding the performance period of the contract, information indicating a condition regarding the position of the mobile object in the performance period of the contract, information indicating the amount of consideration, and information indicating the payment method of the consideration.

In the present embodiment, the dispatch plan storage section 434 stores information regarding at least one dispatch plan of the one or more vehicles 120. The dispatch plan storage section 434 may store, for example, for at least one of the one or more vehicles 120, identification information of the vehicle and information indicating an allocation plan of the vehicle in association with each other. The information indicating the dispatch plan of the vehicle 120 may include information indicating the user of the vehicle 120, information indicating a condition regarding the dispatch time, and information indicating a condition regarding the dispatch position. The dispatch time may be a time when the use of the vehicle 120 is started. The dispatch position may be the position of vehicle 120 in the dispatch time.

In the present embodiment, the payment information storage section 436 stores information regarding payment for each of one or more contracts. For each of one or more contracts, the payment information storage section 436 may store the identification information of the contract and the information regarding the payment of the consideration for the contract in association with each other.

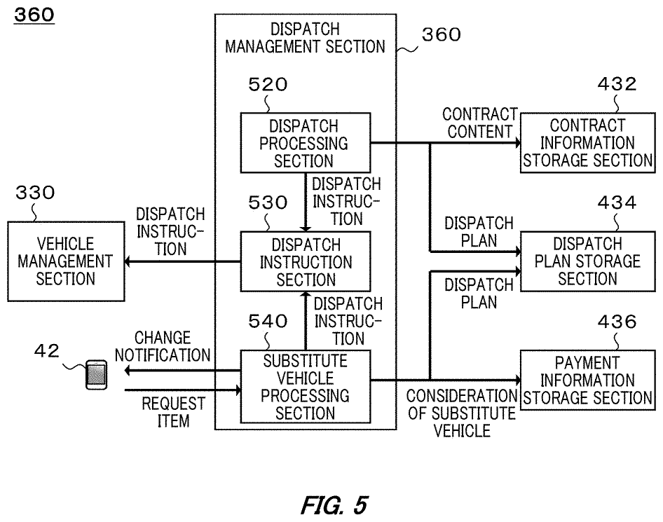

FIG. 5 schematically illustrates an example of an internal configuration of the dispatch management section 360. In the present embodiment, the dispatch management section 360 includes, for example, a dispatch processing section 520, a dispatch instruction section 530, and a substitute vehicle processing section 540.

In the present embodiment, the dispatch processing section 520 executes dispatch processing. For example, the dispatch processing section 520 acquires the first dispatch request from the user 40. The dispatch processing section 520 determines to allocate arbitrary vehicle 120 to the first dispatch request in response to the acquisition of the first dispatch request from the user 40.

More specifically, the dispatch processing section 520 extracts the vehicle 120 allocated in response to the first dispatch request from the one or more vehicles 120 managed by the management server 110. The dispatch processing section 520 may extract the vehicle 120 meeting the condition desired by the user 40 in the first dispatch request as the vehicle 120 allocated in response to the first dispatch request. As a result, the vehicle 120 to be used for performance of the contract established on the basis of the first dispatch request is determined. For example, the dispatch processing section 520 determines to allocate a specific vehicle 122 to the performance of the contract established on the basis of the first dispatch request.

Note that the dispatch processing section 520 may extract a specific vehicle 122 from the one or more vehicles 120 on the basis of contents of other dispatch requests for which the dispatch processing of the vehicle 120 has already been completed. For example, the dispatch processing section 520 first determines the presence or absence of a desired condition regarding a substitute vehicle in a case where the substitute vehicle is arranged in the other dispatch request. In a case where the other dispatch request includes information indicating a desired condition regarding a substitute vehicle, the dispatch processing section 520 extracts the vehicle 120 that is a candidate for the substitute vehicle regarding the other dispatch request. Next, the dispatch processing section 520 determines, from among the one or more vehicles 120 managed by management server 110, a vehicle 120 to be allocated in response to the first dispatch request from among the vehicles 120 different from the vehicle 120 extracted as a candidate substitute vehicle 120.

In the present embodiment, the dispatch processing section 520 may execute a process for dispatching the vehicle 122. More specifically, the dispatch processing section 520 outputs, to the dispatch instruction section 530, an instruction to move the vehicle 122 to a position determined by a contract established on the basis of the first dispatch request by a time determined by the contract.

In the present embodiment, the dispatch instruction section 530 acquires, from the dispatch processing section 520, an instruction to move the vehicle 122 to a position determined by a contract established on the basis of the first dispatch request by a time determined by the contract. The dispatch instruction section 530 transmits the instruction acquired from the dispatch processing section 520 to the vehicle 122 or a communication terminal of the driver of the vehicle 122. Accordingly, by the time indicated by the first dispatch request, an instruction to move the vehicle 122 to the position indicated by the first dispatch request is transmitted to the vehicle 122 or the communication terminal of the driver of the vehicle 122.

In another embodiment, the dispatch instruction section 530 acquires an instruction to move the substitute vehicle 124 from the substitute vehicle processing section 540. The dispatch instruction section 530 transmits the instruction acquired from the substitute vehicle processing section 540 to the substitute vehicle 124 or the communication terminal of the driver of the substitute vehicle 124. As a result, an instruction to move the substitute vehicle 124 is transmitted to the substitute vehicle 124 or the communication terminal of the driver of the substitute vehicle 124.

In the present embodiment, the substitute vehicle processing section 540 executes processing for arranging the substitute vehicle 124 in a case where a predetermined condition (also referred to as a condition regarding arrangement of a substitute vehicle) is satisfied. Details of the substitute vehicle processing section 540 will be described later.

The dispatch processing section 520 may be an example of a first determination section. The dispatch instruction section 530 may be an example of an instruction transmitting section. The substitute vehicle processing section 540 may be an example of a performance determination section, a second determination section, an adjustment section, a consideration determination section, and a notification section.

The substitute vehicle processing section 540 may be an example of an arrival determination section, an arrangement section, a consideration determination section, and a cause determination section. The substitute vehicle processing section 540 may be an example of a consideration amount determination section and a payment method determination section.

The substitute vehicle processing section 540 may be an example of an accident determination section, an arrangement section, a consideration determination section, and a cause determination section. The substitute vehicle processing section 540 may be an example of a consideration amount determination section and a payment method determination section.

The dispatch processing section 520 may be an example of an allocation section. The dispatch instruction section 530 may be an example of an instruction transmitting section. The substitute vehicle processing section 540 may be an example of a limit determination section and the arrangement section.

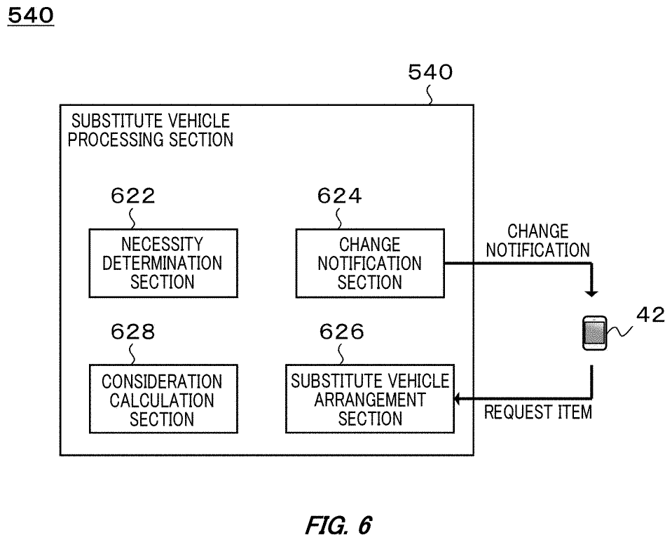

FIG. 6 schematically illustrates an example of an internal configuration of the substitute vehicle processing section 540. In the present embodiment, the substitute vehicle processing section 540 includes, for example, a necessity determination section 622, a change notification section 624, a substitute vehicle arrangement section 626, and a consideration calculation section 628. In the present embodiment, in order to simplify the description, details of the substitute vehicle processing section 540 will be described with reference to FIG. 2. However, it should be noted that the substitute vehicle processing section 540 is not limited to the present embodiment.

In the present embodiment, the necessity determination section 622 determines whether a condition regarding arrangement of a substitute vehicle is satisfied. For example, the necessity determination section 622 determines whether an event that interferes with the operation of the vehicle 122 has occurred. More specifically, the necessity determination section 622 may determine at least one of (i) whether the vehicle 122 can perform the second contract, (ii) whether the vehicle 122 can arrive at the position indicated by the contract information of the second contract by the time indicated by the contract information of the second contract, (iii) whether at least one of a failure and an accident has occurred in the vehicle 122, or whether the probability of occurrence of at least one of a failure and an accident in the vehicle 122 is large, and (iv) whether the movement of the vehicle 122 is restricted.

The condition regarding the arrangement of the substitute vehicle may be that the vehicle 122 cannot perform the second contract. The condition regarding the arrangement of the substitute vehicle may be that the vehicle 122 cannot arrive at the position indicated by the contract information of the second contract by the time indicated by the contract information of the second contract.

The condition regarding the arrangement of the substitute vehicle may be that at least one of a failure and an accident has occurred in the vehicle 122. The condition regarding the arrangement of the substitute vehicle may be that the probability of occurrence of at least one of a failure and an accident in the vehicle 122 is high. The condition regarding the arrangement of the substitute vehicle may be that the probability of occurrence of at least one of a failure and an accident in the vehicle 122 is larger than a predetermined criterion. The failure or the accident described above may be a failure or an accident in which the scale of the failure or the accident meets a specific criterion. The occurrence of at least one of a failure and an accident in the vehicle 122 may be an example of an event that interferes with the operation of the vehicle 122.

The condition regarding the arrangement of the substitute vehicle may be that the movement of the vehicle 122 is restricted. The condition for arranging a substitute vehicle may be that the scale of the restriction on the movement of the vehicle 122 meets a specific criterion. The restriction on the movement of the vehicle 122 may be an example of an event that interferes with the operation of the vehicle 122.

The necessity determination section 622 may determine whether the condition regarding the arrangement of the substitute vehicle is established before the performance period of the second contract. After the vehicle 122 is allocated in response to the second dispatch request, the necessity determination section 622 may determine whether the condition regarding the arrangement of the substitute vehicle is established before the performance period of the second contract. The performance period of the second contract may be the vehicle dispatch time indicated by the second contract.

[First Specific Example of Determination Processing]

In the present embodiment, the necessity determination section 622 determines whether the vehicle 122 can perform the second contract. In a case where it is determined that the second contract cannot be performed by the vehicle 122, the necessity determination section 622 may determine to arrange the substitute vehicle 124 to the getting-on point 222.

According to one embodiment, the necessity determination section 622 determines that the vehicle 122 cannot perform the second contract in a case where occurrence of an event that interferes with the operation of the vehicle 122 is detected. For example, in a case where at least one of (i) a failure of the vehicle 122, (ii) an accident involving the vehicle 122, and (iii) restriction on the movement of the vehicle 122 is detected, the necessity determination section 622 determines that the vehicle 122 cannot perform the second contract. The necessity determination section 622 may determine that the performance of the second contract by the vehicle 122 is impossible in a case where at least one of (i) the scale of the failure of the vehicle 122 meets a specific criterion, (ii) the scale of the accident of the vehicle 122 meets a specific criterion, and (iii) the scale of the restriction on the movement of the vehicle 122 meets a specific criterion is detected.

As the restriction on the movement of the vehicle 122, at least one of the occurrence of an accident on a route on which the vehicle 122 has been scheduled to move, the occurrence of traffic jam on the route, and the traffic restriction on a partial route on the route is exemplified. Note that it may be determined that the movement of the vehicle 122 is restricted in a case where the scale of the accident, the traffic jam, and the traffic restriction described above meets a specific criterion.

In another embodiment, the necessity determination section 622 determines whether the vehicle 122 can arrive at the position (that is, the getting-on point 222) indicated by the second contract by the performance period (that is, time t202) of the second contract. In a case where it is determined that the vehicle 122 cannot arrive at the getting-on point 222 by time t202, the necessity determination section 622 may determine that the vehicle 122 cannot perform the second contract.

[Second Specific Example of Determination Processing]

In the present embodiment, the necessity determination section 622 determines whether the vehicle 122 can arrive at the getting-on point 222 by time t202. In a case where it is determined that the vehicle 122 cannot arrive at the getting-on point 222 by time t202, the necessity determination section 622 may determine to arrange the substitute vehicle 124 to the getting-on point 222.

For example, the necessity determination section 622 first refers to the contract information storage section 432 to acquire the contract information of the second contract. Next, the necessity determination section 622 analyzes the contract information and determines that the time indicated by the contract information of the second contract is time t202 and the position indicated by the contract information of the second contract is the getting-on point 222. Thereafter, the necessity determination section 622 determines whether the vehicle 122 can arrive at the getting-on point 222 by time t202.

The necessity determination section 622 may determine whether the vehicle 122 can arrive at the getting-on point 222 by time t202 on the basis of the information collected by the vehicle management section 330. For example, the necessity determination section 622 determines whether the vehicle 122 can arrive at the getting-on point 222 by time t202 on the basis of the information indicating a traffic state on the route from the current position of the vehicle 122 to the getting-on point 222, a distance from the current position of the vehicle 122 to the getting-on point 222, and an average speed per hour of the vehicle 122.

[Third Specific Example of Determination Processing]

In the present embodiment, the necessity determination section 622 determines whether an event that interferes with the operation of the vehicle 122 has occurred. For example, the necessity determination section 622 determines whether at least one of a failure and an accident has occurred in the vehicle 122, or whether a probability of occurrence of at least one of a failure and an accident in the vehicle 122 is large. In a case where it is determined that at least one of a failure and an accident has occurred in the vehicle 122, or a case where it is determined that the probability of occurrence of at least one of a failure and an accident in the vehicle 122 is high, the necessity determination section 622 may determine to arrange the substitute vehicle 124 to the occurrence point of the accident 62 or the accident 64.

In one embodiment, in a case where the substitute vehicle 124 is arranged to the occurrence point of the accident 62 or the accident 64 in a period before the performance period of the second contract, the necessity determination section 622 may determine whether to arrange another substitute vehicle 124 to the getting-on point 222. For example, in a case where the second contract can be performed after the substitute vehicle 124 arranged to the occurrence point of the accident 62 or the accident 64 is used by the user 40 of the first contract, the necessity determination section 622 does not need to arrange another substitute vehicle 124 to the getting-on point 222. On the other hand, in a case where the second contract cannot be performed after the substitute vehicle 124 arranged to the occurrence point of the accident 62 or the accident 64 is used by the user 40 of the first contract, the necessity determination section 622 may arrange another substitute vehicle 124 to the getting-on point 222.

In another embodiment, in a case where a person is on the vehicle 122 or an object is mounted on the vehicle 122, the necessity determination section 622 determines to arrange another substitute vehicle 124 to the getting-on point 222. The case where the object is mounted on the vehicle 122 may be a case where the vehicle 122 transports the object on the basis of the contract. On the other hand, in a case where no person is on the vehicle 122 or a case where no object is mounted on the vehicle 122, the necessity determination section 622 may not arrange another substitute vehicle 124 to the getting-on point 222.

For example, the necessity determination section 622 refers to the vehicle information storage section 422 to acquire information indicating at least one of the position and the state of the vehicle 122. Next, the necessity determination section 622 determines whether at least one of a failure and an accident has occurred in the vehicle 122 or whether a probability of occurrence of at least one of a failure and an accident in the vehicle 122 is large on the basis of information indicating at least one of the position and the state of the vehicle 122.

More specifically, for example, in a case where (i) the vehicle 122 is sending an emergency call, or (ii) at least one of the advanced driving assistance system, the collision avoidance system, the automatic brake system, the automatic steering system, and the air bag mounted on the vehicle 122 is in operation, and the average moving speed of the vehicle 122 is smaller than a predetermined value, the necessity determination section 622 determines that at least one of a failure and an accident has occurred in the vehicle 122.

[Fourth Specific Example of Determination Processing]

In the present embodiment, the necessity determination section 622 determines whether the movement of the vehicle 122 is restricted. In a case where it is determined that the movement of the vehicle 122 is restricted, the necessity determination section 622 may determine to arrange the substitute vehicle 124 to or near the current position (typically, it is an occurrence point of the accident 62 or the accident 64) of the vehicle 122. In the present embodiment, the dispatch point of the substitute vehicle 124 may be determined on the basis of an instruction or a request of the user 40.

In a case where the substitute vehicle 124 is arranged to or near the current position of the vehicle 122 in a period before the performance period of the second contract, the necessity determination section 622 may determine whether to arrange another substitute vehicle 124 to the getting-on point 222. For example, in a case where the second contract can be performed after the substitute vehicle 124 arranged to or near the current position of the vehicle 122 is used by the user 40 of the first contract, the necessity determination section 622 may not arrange another substitute vehicle 124 to the getting-on point 222. On the other hand, in a case where the second contract cannot be performed after the substitute vehicle 124 arranged to or near the current position of the vehicle 122 is used by the user 40 of the first contract, the necessity determination section 622 may arrange another substitute vehicle 124 to the getting-on point 222.

For example, the necessity determination section 622 refers to the vehicle information storage section 422 to acquire information indicating at least one of the position and the state of the vehicle 122. Next, the necessity determination section 622 determines whether the movement of the vehicle 122 is restricted on the basis of information indicating at least one of the position and the state of the vehicle 122.

In one embodiment, the necessity determination section 622 determines whether at least one of a failure and an accident has occurred in the vehicle 122 on the basis of the above information. In a case where it is determined that at least one of a failure and an accident has occurred in the vehicle 122, the necessity determination section 622 determines that the movement of the vehicle 122 is restricted.

In another embodiment, the necessity determination section 622 may determine the presence or absence of at least one of an accident, a traffic jam, and a traffic restriction on the moving route of the vehicle 122 on the basis of the above information. In a case where it is determined that at least one of an accident, a traffic jam, and a traffic restriction has occurred on the moving route of the vehicle 122, the necessity determination section 622 determines that the movement of the vehicle 122 is restricted.

In the present embodiment, in a case where the content of the second contract is changed due to the arrangement of the substitute vehicle 124 instead of the vehicle 122, the change notification section 624 transmits a message indicating that the change has occurred in the contract content to the communication terminal 42 of the user 40 of the second contract. In a case where a part of the second contract is not performed because the substitute vehicle 124 is arranged instead of the vehicle 122, the change notification section 624 may transmit a message indicating contents not performed to the communication terminal 42 of the user 40 of the second contract.

For example, in a case where a condition regarding the attribute of the dispatched vehicle 120 is specified in the second contract, there is a possibility that the attribute of the substitute vehicle 124 does not meet at least a part of the condition regarding the attribute of the vehicle 120 specified in the second contract. At this time, the change notification section 624 may notify the communication terminal 42 used by the user 40 of the second contract of a message indicating that the attribute of the substitute vehicle 124 does not meet the condition regarding the attribute of the vehicle 120 indicated by the second contract.

The above message may include a message for confirming whether the management server 110 may arrange the substitute vehicle 124. In this case, the management server 110 may execute the dispatch processing of the substitute vehicle 124 in a case where acquiring information indicating that the substitute vehicle 124 may be arranged from the communication terminal 42. The management server 110 may suspend or stand by for the execution of the dispatch processing of the substitute vehicle 124 until information indicating that the substitute vehicle 124 may be arranged is acquired from the communication terminal 42.

The above message may include a message regarding a change in consideration for the use of the vehicle 122. The above message may include a message regarding a consideration for the use of the substitute vehicle 124.

In the present embodiment, the substitute vehicle arrangement section 626 extracts the vehicle 120 used as the substitute vehicle 124 from the one or more vehicles 120 managed by the management server 110. For example, the substitute vehicle arrangement section 626 acquires, from the necessity determination section 622, information indicating that the substitute vehicle 124 is to be arranged. In response to the acquisition of the information, the substitute vehicle arrangement section 626 may determine the vehicle 120 to be used as the substitute vehicle 124 by a procedure similar to the dispatch processing in the dispatch processing section 520.

The substitute vehicle arrangement section 626 may acquire information indicating that a rescue request has been reported to the emergency lifesaving server 134. The substitute vehicle arrangement section 626 acquires the information regarding the rescue request from, for example, the vehicle 122 or the communication terminal 42 of the user 40 using the vehicle 122. The substitute vehicle arrangement section 626 may acquire the information regarding the rescue request from the emergency lifesaving server 134.

In a case where the substitute vehicle arrangement section 626 acquires the information regarding the rescue request, the substitute vehicle arrangement section 626 may determine to arrange a plurality of substitute vehicles 124. For example, the substitute vehicle arrangement section 626 arranges a larger number of substitute vehicles 124 than the number of vehicles 122. As a result, the substitute vehicle arrangement section 626 can arrange the substitute vehicle 124 to be used by the other party in the accident separately from the substitute vehicle 124 for the user 40 using the vehicle 122.

Conversely, in a case where the substitute vehicle arrangement section 626 acquires the information regarding the rescue request, the substitute vehicle arrangement section 626 may determine not to arrange the substitute vehicle 124. As a result, for example, in a case where the party in the accident is carried by an ambulance, it is suppressed that the substitute vehicle 124 goes to the accident site.

In the present embodiment, the substitute vehicle arrangement section 626 may acquire information indicating a condition desired or requested by the user 40 who uses the vehicle 122 on the basis of the second contract for the substitute vehicle 124. The substitute vehicle arrangement section 626 may determine the substitute vehicle 124 on the basis of the condition desired or requested by the user 40 for the substitute vehicle 124.

The substitute vehicle arrangement section 626 may acquire information indicating a condition desired or requested by the user 40 for the substitute vehicle 124 in a period before time t202. For example, the substitute vehicle arrangement section 626 may acquire information indicating a condition desired or requested by the user 40 for the substitute vehicle 124 via the dispatch request screen generated by the screen generation section 340.

The information indicating a condition desired or requested by the user 40 for the substitute vehicle 124 may include information indicating a condition regarding the attribute of the vehicle 120 used as the substitute vehicle 124. The information indicating a condition desired or requested by the user 40 for the substitute vehicle 124 may include information indicating which of the attribute of the vehicle 120 used as the substitute vehicle 124 and the arrival time of the substitute vehicle 124 is prioritized. As a specific example of the attribute of the vehicle 120 used as the substitute vehicle 124, an attribute similar to the specific example of the attribute of the vehicle 120 described above is exemplified.

In one embodiment, the substitute vehicle arrangement section 626 extracts the vehicle 120 that can arrive at the getting-on point 222 by time t202 as the substitute vehicle 124 from among the one or more vehicles 120 managed by the management server 110. The substitute vehicle arrangement section 626 may extract, as the substitute vehicle 124, the vehicle 120 that can arrive at the getting-on point 222 by (i) time t202 and that meets the condition regarding the attribute of the vehicle 120 specified in the second contract from among the one or more vehicles 120 managed by the management server 110.

In another embodiment, the substitute vehicle arrangement section 626 extracts the vehicle 120 having the earliest estimated time of arrival at the getting-on point 222 from among the one or more vehicles 120 managed by the management server 110 as the substitute vehicle 124. The substitute vehicle arrangement section 626 may extract, as the substitute vehicle 124, the vehicle 120 having the earliest estimated time of arrival at the getting-on point 222 among the vehicles 120 meeting the condition regarding the attribute of the vehicle 120 specified in the second contract from among the one or more vehicles 120 managed by the management server 110.

In a case where the condition desired or requested by the user 40 who uses the vehicle 122 on the basis of the second contract for the substitute vehicle 124 includes information indicating that the attribute of the substitute vehicle 124 is prioritized over the arrival time of the substitute vehicle 124, the substitute vehicle arrangement section 626 may determine, as the substitute vehicle 124, the vehicle 120 that meets the condition regarding the attribute indicated by the user 40 or the vehicle 120 having an attribute identical with or similar to the attribute of the vehicle 122. On the other hand, in a case where information indicating that the arrival time of the substitute vehicle 124 is prioritized over the attribute of the substitute vehicle 124 is included as the condition desired or requested by the user 40 for the substitute vehicle 124, the substitute vehicle arrangement section 626 may determine, as the substitute vehicle 124, the vehicle 120 having the earliest scheduled time at which the user 40 using the vehicle 122 can join.

In the present embodiment, the substitute vehicle arrangement section 626 may execute processing for dispatching the substitute vehicle 124. The substitute vehicle arrangement section 626 may execute processing for dispatching the substitute vehicle 124 by a procedure similar to the processing in the dispatch processing section 520.

In one embodiment, the substitute vehicle arrangement section 626 determines to move the substitute vehicle 124 to the getting-on point 222. The substitute vehicle arrangement section 626 may determine to move the substitute vehicle 124 to the getting-on point 222 by time t202.

In another embodiment, the substitute vehicle arrangement section 626 determines to move the substitute vehicle 124 to the occurrence point of the accident 62 or the accident 64. The substitute vehicle arrangement section 626 may determine to move some of the plurality of substitute vehicles 124 to the occurrence point of the accident 62 or the accident 64, and move the rest of the plurality of substitute vehicles 124 to the getting-on point 222.

In still another embodiment, the substitute vehicle arrangement section 626 determines to move the substitute vehicle 124 to or near the current position of the vehicle 122 whose movement is restricted, or the position instructed by the user 40. The substitute vehicle arrangement section 626 may determine to move some of the plurality of substitute vehicles 124 to or near the current position of the vehicle 122 whose movement is restricted, or the position instructed by the user 40, and move the rest of the plurality of substitute vehicles 124 to the getting-on point 222.

In the present embodiment, the consideration calculation section 628 determines various items regarding consideration for the use of the vehicle 120. In one embodiment, the consideration calculation section 628 determines a condition regarding the consideration in a case where the contract regarding the use of the vehicle 120 is fully performed. In another embodiment, the consideration calculation section 628 determines a condition regarding the consideration in a case where a part of the contract regarding the use of the vehicle 120 is not performed. In still another embodiment, the consideration calculation section 628 determines a condition regarding the consideration in a case where the entire contract regarding the use of the vehicle 120 is not performed.

As a result, for example, in a case where a part or all of the second contract is not performed due to dispatching of the substitute vehicle 124 instead of the vehicle 122, the content of at least one of the claims and the liabilities between the parties of the second contract may be adjusted. The consideration calculation section 628 may determine that a part of the contract is not performed in a case where (i) some of a plurality of terms included in a single contract regarding the use of the vehicle 120 is not performed, or (ii) a case where at least parts of some contracts in a plurality of contracts concluded in connection with the use of the vehicle 120 is not performed. The plurality of contracts may be contracts closely related to each other.

For example, the consideration calculation section 628 determines the amount of consideration. The amount of consideration may be the number or amount of consideration. In a case where the type of consideration is other than the monetary value, the amount of consideration may be an amount equivalent to money. The consideration calculation section 628 may determine a payment method of the consideration. As the payment method of the consideration, the type of consideration, the type of payment means, and the like are exemplified.

Examples of the type of consideration include (i) monetary value, (ii) electronic value, (iii) financial value, and (iv) right. Examples of the monetary value include currency and money. Examples of the electronic value include points, mileage, electronic money, and the like. Examples of the financial value include cryptocurrency. Note that the cryptocurrency may be an example of a monetary value or an electronic value depending on the country. Examples of the rights include a right to preferentially use the vehicle 120, a right to use a service provided by the management system 100, a right to receive a product (also referred to as a coupon or the like), and the like. Examples of the type of payment means include cash payment, credit card payment, electronic payment, cashback, electronic value offset, offset with other values, and the like.

As described above, the second contract may include a condition regarding the attribute of the vehicle 120 used for the performance of the second contract. In one embodiment, in a case where the attribute of the substitute vehicle 124 does not meet the condition regarding the attribute of the vehicle 120 specified in the second contract, the consideration calculation section 628 determines that the amount of consideration for the use of the vehicle 122 is reduced as compared with the case where the attribute of the substitute vehicle 124 meets the condition regarding the attribute of the vehicle 120 specified in the second contract. Accordingly, in a case where a part of the second contract is not performed, the content of at least one of the claims and the liabilities between the parties of the second contract is adjusted.

In another embodiment, in a case where the attribute of the substitute vehicle 124 does not meet the condition regarding the attribute of the vehicle 120 specified in the second contract, the consideration calculation section 628 determines that at least one of (i) the monetary value, (ii) the electronic value, (iii) the financial value, and (iv) the right is granted to at least one of the user 40 and the party of the user 40 related to the second contract. Accordingly, in a case where a part of the second contract is not performed, the content of at least one of the claims and the liabilities between the parties of the second contract is adjusted.

In the present embodiment, for example, the consideration calculation section 628 determines the consideration so that the amount of consideration for the use of the vehicle 120 differs between a case where the contract regarding the use of the vehicle 120 includes the information specifying the attribute of the vehicle 120 used for the performance of the contract and a case where the contract does not include the information specifying the attribute of the vehicle 122 used for the performance of the contract. The consideration calculation section 628 may determine the consideration so that the amount of consideration for the use of the vehicle 120 differs between a case where the contract regarding the use of the vehicle 120 includes the information specifying the attribute of the vehicle 120 used for the performance of the contract and a case where the contract does not include the information specifying the attribute of the substitute vehicle 124 used for the performance of the contract.

In the present embodiment, for example, the consideration calculation section 628 determines the consideration so that the amount of consideration for the use of the vehicle 120 differs between a case where the contract regarding the use of the vehicle 120 includes the information specifying a first attribute of the vehicle 120 used for the performance of the contract and a case where the contract does not include the information specifying the first attribute of the vehicle 122 used for the performance of the contract. The consideration calculation section 628 may determine the consideration so that the amount of consideration for the use of the vehicle 120 differs between a case where the contract regarding the use of the vehicle 120 includes the information specifying the first attribute of the vehicle 120 used for the performance of the contract and a case where the contract does not include the information specifying the first attribute of the substitute vehicle 124 used for the performance of the contract.

In the present embodiment, for example, the consideration calculation section 628 determines the consideration so that the amount of consideration for the use of the vehicle 120 differs between a case where the contract regarding the use of the vehicle 120 includes the information specifying the first attribute of the vehicle 120 used for the performance of the contract and a case where the contract includes the information specifying a second attribute of the vehicle 122 used for the performance of the contract. The consideration calculation section 628 may determine the consideration so that the amount of consideration for the use of the vehicle 120 differs between a case where the contract regarding the use of the vehicle 120 includes the information specifying the first attribute of the vehicle 120 used for the performance of the contract and a case where the contract includes the information specifying the second attribute of the substitute vehicle 124 used for the performance of the contract. The first attribute and the second attribute may be different from each other.

In the present embodiment, (i) in a case where the user 40 who uses the vehicle 122 according to the second contract is the owner 20 of the vehicle 122 or a person (also referred to as the owner 20 of the vehicle 122 or the like) who uses the vehicle 122 for the owner 20, the consideration calculation section 628 may not claim the amount of consideration for the use of the vehicle 122. Even in this case, the consideration calculation section 628 may charge an amount corresponding to the usage fee of the management system 100. In addition, the consideration calculation section 628 may determine the amount of consideration for the use of the substitute vehicle 124 such that the amount of consideration for the use of the substitute vehicle 124 differs between (i) a case where the user 40 who uses the vehicle 122 according to the second contract is the owner 20 of the vehicle 122 or the like and (ii) a case where the user 40 who uses the vehicle 122 according to the second contract is not the owner 20 of the vehicle 122 or the like.

In the present embodiment, the consideration calculation section 628 may determine the cause for which the arrangement of the substitute vehicle 124 is necessary. The consideration calculation section 628 may determine the amount of consideration for the use of the substitute vehicle 124 on the basis of the cause that the arrangement of the substitute vehicle 124 is required. The consideration calculation section 628 may determine the amount of consideration for the use of the substitute vehicle 124 such that the amount of consideration for the use of the substitute vehicle 122 differs between (i) a case where the cause that the arrangement of the substitute vehicle 124 to be used instead of the vehicle 122 is caused by the owner 20 of the vehicle 122 or the like and (ii) a case where the cause is not caused by the owner 20 of the vehicle 124 or the like.

In a case where the user of the vehicle 122 is the owner 20 of the vehicle 122 or the like, the consideration calculation section 628 may determine the amount of consideration for the use of the substitute vehicle 124 such that the amount of consideration in a case where the cause is caused by the owner 20 of the vehicle 122 or the like is larger than the amount of consideration in a case where the cause is not caused by the owner 20 of the vehicle 122 or the like. In a case where the user of the vehicle 122 is the owner 20 of the vehicle 122 or the like and the cause is not caused by the owner 20 of the vehicle 122 or the like, the consideration calculation section 628 may determine the amount of consideration for the use of the substitute vehicle 124 such that the amount of consideration for the use of the substitute vehicle 124 is smaller than the amount of consideration for the use of the vehicle 122.

In this case, the amount of consideration for the use of the substitute vehicle 124 may be free. (i) monetary value, (ii) electronic value, (iii) financial value, (iv) rights, and the like may be granted such that the usage fee of the substitute vehicle 124 is substantially free.

The cause that the arrangement of the substitute vehicle 124 to be used instead of the vehicle 122 becomes necessary may be the cause that the performance of the second contract by the vehicle 122 becomes impossible, or may be the cause that the vehicle 122 becomes impossible to arrive at the getting-on point 222 by time t202. The cause of the need to arrange the substitute vehicle 124 may be a cause of a failure of the vehicle 122, a cause of an accident involving the vehicle 122, or a cause of restriction on the movement of the vehicle 122.

According to one embodiment, in a case where the cause of the need to arrange the substitute vehicle 124 is caused by a maintenance failure of the vehicle 122, the consideration calculation section 628 determines that the cause is caused by the owner 20 of the vehicle 122 or the like. More specifically, the consideration calculation section 628 acquires maintenance information indicating a maintenance status of the vehicle 122. The consideration calculation section 628 may acquire the maintenance information from the maintenance server 132, or may acquire the maintenance information collected by the vehicle management section 330 with reference to the vehicle information storage section 422.

On the basis of the maintenance information of the vehicle 122, the consideration calculation section 628 determines whether the cause of the need to arrange the substitute vehicle 124 is due to a maintenance failure of the vehicle 122.

According to another embodiment, in a case where the cause of the need to arrange the substitute vehicle 124 is caused by an accident between the vehicle 122 and the third party, and the percentage of negligence of the third party satisfies a predetermined condition, the consideration calculation section 628 determines that the cause is not caused by the owner 20 of the vehicle 122 or the like. According to another embodiment, in a case where the cause of the need to arrange the substitute vehicle 124 is caused by a traffic situation, the consideration calculation section 628 determines that the cause is not caused by the owner 20 of the vehicle 122 or the like.

According to still another embodiment, in a case where the necessity determination section 622 determines that an accident involving the vehicle 122 has occurred, or in a case where the necessity determination section 622 determines that a probability of occurrence of an accident involving the vehicle 122 is high, in a case where (i) the vehicle 122 is in the manual driving mode and the other party of the accident is another mobile object operating in the automatic driving mode, or (ii) the vehicle 122 is in the manual driving mode and an operation status of a device mounted on the vehicle 122 satisfies a predetermined condition, the consideration calculation section 628 determines that the cause is caused by the owner 20 of the vehicle 122 or the like. On the other hand, in a case where the necessity determination section 622 determines that an accident involving the vehicle 122 has occurred, or in a case where the necessity determination section 622 determines that the probability of occurrence of an accident involving the vehicle 122 is high, in a case where the vehicle 122 is in the automatic driving mode, the consideration calculation section 628 determines that the cause is not caused by the owner 20 of the vehicle 122 or the like.

The necessity determination section 622 may be an example of the performance determination section. The change notification section 624 may be an example of the notification section. The substitute vehicle arrangement section 626 may be an example of the second determination section. The consideration calculation section 628 may be an example of the adjustment section and the consideration determination section.

The necessity determination section 622 may be an example of a reservation information acquisition section and the arrival determination section. The substitute vehicle arrangement section 626 may be an example of the arrangement section. The consideration calculation section 628 may be an example of a maintenance information acquisition section, the consideration determination section, the consideration amount determination section, the payment method determination section, and the cause determination section.

The necessity determination section 622 may be an example of the reservation information acquisition section, the mobile object information acquisition section, and the accident determination section. The substitute vehicle arrangement section 626 may be an example of the arrangement section. The consideration calculation section 628 may be an example of the consideration determination section, the consideration amount determination section, and the cause determination section.

The necessity determination section 622 may be an example of the mobile object information acquisition section and the limit determination section. The substitute vehicle arrangement section 626 may be an example of the arrangement section and the condition information acquisition section.

The case where the attribute of the substitute vehicle 124 meets the condition regarding the attribute of the vehicle 120 specified in the second contract may be an example of the case where the second contract is performed. The user 40 related to the second contract may be an example of at least one of an applicant who has applied for the use of the vehicle 120 according to the second contract and a user who uses the vehicle 120 according to the second contract. The party of the user 40 related to the second contract may be an example of a user who uses the vehicle 120 according to the second contract. The user 40 who uses the vehicle 122 according to the second contract may be an example of the user of the first mobile object indicated by the contract information. The performance period of the second contract may be an example of the reservation time.

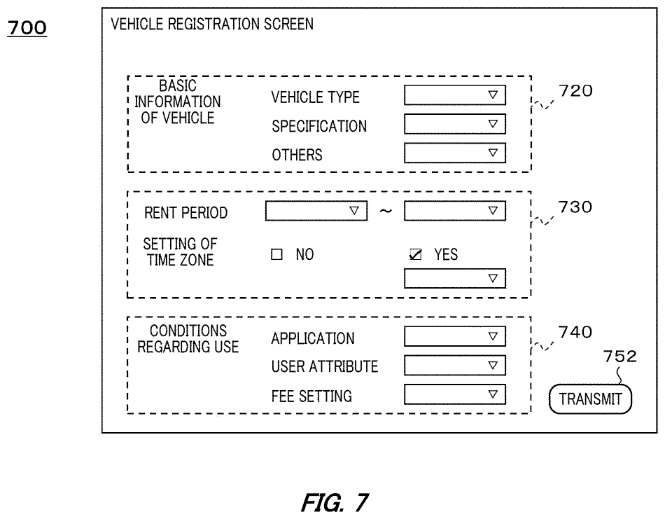

FIG. 7 schematically illustrates an example of a screen 700. The screen 700 may be an example of the vehicle registration screen. The screen 700 may be an example of a screen used for vehicle registration processing for the owner 20 to register the own vehicle 120 as the vehicle 120 available for rent to another person in the management server 110.

In the present embodiment, an input reception section 720 to which basic information of the vehicle 120 is input, an input reception section 730 to which information regarding a rent period of the vehicle 120 is input, and an input reception section 740 to which a condition regarding use of the vehicle 120 is input are arranged on the screen 700. On the screen 700, an icon 752 in which a command for executing processing of transmitting the matter input on the screen 700 to the management server 110 is embedded may be arranged.

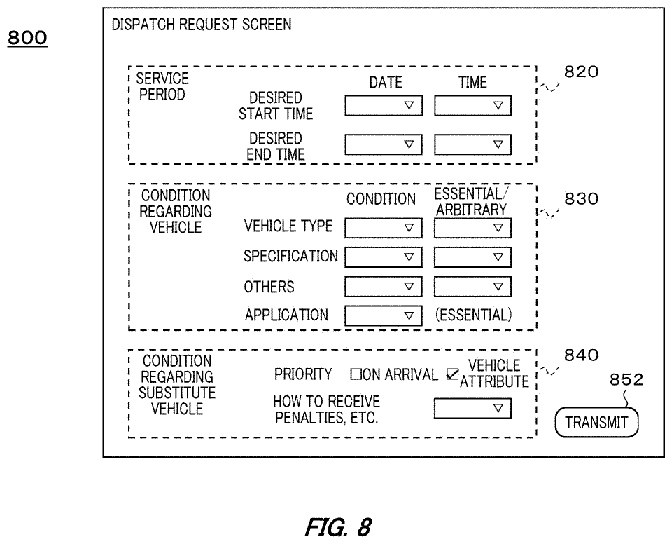

FIG. 8 schematically illustrates an example of a screen 800. The screen 800 may be an example of the dispatch request screen. The screen 800 may be an example of a screen used for dispatch request processing for the user 40 to request the management server 110 to use the vehicle 120.

In the present embodiment, the screen 800 is provided with an input reception section 820 to which a desired condition regarding a service period of the vehicle 120 is input, an input reception section 830 to which a desired condition regarding the attribute of the vehicle 120 is input, and an input reception section 840 to which a desired condition regarding the arrangement of a substitute vehicle is input in a case where the arrangement of the substitute vehicle is required. On the screen 800, an icon 852 in which a command for executing processing of transmitting the matter input on the screen 800 to the management server 110 is embedded may be arranged.

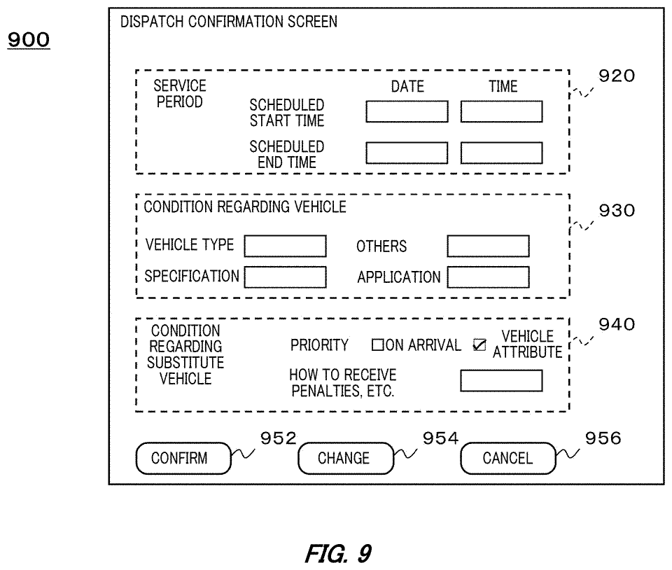

FIG. 9 schematically illustrates an example of a screen 900. The screen 900 may be an example of the dispatch confirmation screen. The screen 900 may be an example of a screen used for the dispatch confirmation process in order for the management server 110 to present the content of the contract established on the basis of the dispatch request from the user 40 to the user 40.

In the present embodiment, an area 920 in which a condition regarding a service period of the vehicle 120 is presented, an area 930 in which a condition regarding an attribute of the vehicle 120 is presented, and an area 940 in which a condition regarding arrangement of a substitute vehicle is presented are arranged on the screen 900. On the screen 900, an icon 952 in which a command for executing processing of transmitting information indicating that the user 40 has confirmed that there is no difference in the information presented on the screen 900 to the management server 110 is embedded may be arranged. On the screen 900, an icon 954 in which a command for requesting the management server 110 to perform processing for changing the input content is embedded may be arranged. On the screen 900, an icon 956 in which a command for requesting the management server 110 to perform processing for canceling the input content or the dispatch request is embedded may be arranged.

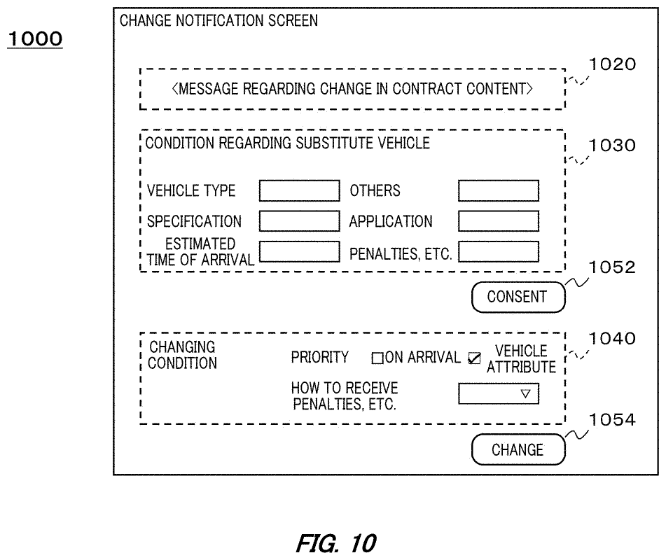

FIG. 10 schematically illustrates an example of a screen 1000. The screen 1000 may be an example of the change notification screen. The screen 1000 may be an example of a screen used for a change notification process for the management server 110 to present the content of change to the user 40 in a case where the contract content with the user 40 is changed according to the arrangement of the substitute vehicle 124 by the management server 110.

In the present embodiment, the screen 1000 includes an area 1020 in which a message regarding the change of the contract content is presented and an area 1030 in which information regarding the substitute vehicle selected by the management server 110 is presented. On the screen 1000, an icon 1052 in which a command for executing processing of transmitting information indicating that the user 40 accepts the information presented in the area 1020 and the area 1030 to the management server 110 is embedded may be arranged.

In the present embodiment, the screen 1000 may be provided with an input reception section 1040 to which information for the user 40 to change information regarding the arrangement of a substitute vehicle is input. On the screen 1000, an icon 1054 in which a command for executing processing of transmitting the matter input to the input receiving section 1040 to the management server 110 is embedded may be arranged.

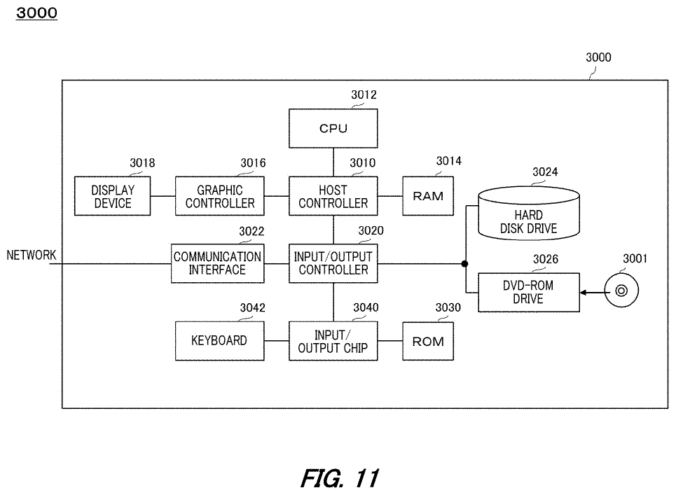

FIG. 11 illustrates an example of a computer 3000 in which a plurality of aspects of the present invention may be fully or partially embodied. The management system 100 or a part thereof may be realized by the computer 3000. For example, the management system 100 or a part thereof is realized by the computer 3000. The vehicle 120 or a part thereof may be realized by the computer 3000. For example, a control apparatus that is mounted on the vehicle 120 and controls the vehicle 120 or a part thereof is realized by the computer 3000.

The program installed in the computer 3000 can make the computer 3000 function as an operation associated with an apparatus according to the embodiment of the present invention or as one or more “section” of said apparatus, or make it execute said operation or said one or more “section”, and/or make the computer 3000 execute a process according to the embodiment of the present invention or the step of said process. Such program may be executed by the CPU 3012, so as to make the computer 3000 execute given operation associated with some or all of the flowcharts and the blocks of the block diagrams described in this specification.

The computer 3000 according to this embodiment includes the CPU 3012, the RAM 3014, the graphic controller 3016 and the display device 3018, and they are connected to each other by the host controller 3010. The computer 3000 further includes the communication interface 3022, the hard disk drive 3024, the DVD-ROM drive 3026 and the input/output unit such as an IC card drive, and they are connected to the host controller 3010 via the input/output controller 3020. The computer further includes the ROM 3030 and the legacy input/output unit such as the keyboard 3042, and they are connected to the input/output controller 3020 via the input/output chip 3040.

The CPU 3012 acts pursuant to the program stored in the ROM 3030 and the RAM 3014, and controls respective units by them. The graphic controller 3016 acquires image data generated by the CPU 3012 on a frame buffer or the like provided in the RAM 3014 or in itself, and causes the image data to be displayed on the display device 3018.

The communication interface 3022 communicates with other electronic devices via the network. The hard disk drive 3024 stores the program and data to be used by the CPU 3012 in the computer 3000. The DVD-ROM drive 3026 reads a program or data from the DVD-ROM 3001, and provides the program or data to the hard disk drive 3024 via the RAM 3014. The IC card drive reads the program and data from the IC card, and/or writes the program and data to the IC card.

The ROM 3030 stores a boot program, etc. executed by the computer 3000 at the time of activation, and/or a program dependent on the hardware of the computer 3000. The input/output chip 3040 may connect various input/output units to the input/output controller 3020, via a parallel port, a serial port, a keyboard port, a mouse port, etc.

A program is provided by a computer-readable storage medium like the DVD-ROM 3001 or the IC card. A program is read from the computer-readable storage medium, and installed in the hard disk drive 3024, the RAM 3014 or the ROM 3030, which are the examples of computer-readable storage media, and then executed by the CPU 3012. Information processing described in these programs are read by the computer 3000, and results in cooperation between the program and the above-described various types of hardware resources. An apparatus or method may be configured by realizing an operation or processing of information pursuant to the use of the computer 3000.

For example, if a communication is executed between the computer 3000 and an external device, the CPU 3012 may execute the communication program loaded on the RAM 3014 to instruct communication processing, based on the processing described in the communication program, to the communication interface 3022. The communication interface 3022 reads, under the control by the CPU 3012, the transmission data stored in the transmission buffer region provided in a storage medium such as a RAM 3014, a hard disk drive 3024, a DVD-ROM 3001 or an IC card, sends the transmission data so read to the network, or writes the received data received from the network into a reception buffer region etc. provided on the storage medium.

Also, the CPU 3012 may make all or the necessary portion of a file or a database stored in an external storage medium such as a hard disk drive 3024, a DVD-ROM drive 3026 (DVD-ROM 3001), or an IC card be able to be read by the RAM 3014, to accordingly execute various types of processing to the data on the RAM 3014. Then, the CPU 3012 may write back the processed data into an external storage medium.

Various types of programs, data, table and various types of information such as a database may be stored in a storage medium to receive information processing. The CPU 3012 may execute, against the data read from the RAM 3014, various types of processing, including various types of operations designated by an instruction sequence of a program, which are described throughout this disclosure, an information processing, a condition judgment, a conditional branch, an unconditional branch, information search/replacement, etc., and write back the result to the RAM 3014. Moreover, the CPU 3012 may search information in a file in a storage medium, in a database, etc. For example, if multiple entries, each having an attribute value of a first attribute associated with an attribute value of a second attribute, are stored in the storage medium, the CPU 3012 may search an entry matching with the condition in which the attribute value of the first attribute is designated from among said multiple entries, read the attribute value of the second attribute stored in said entry, and thereby acquire the attribute value of the second attribute associated with the first attribute which satisfies the predetermined condition.

A program or a software module explained above may be stored in a computer 3000 or in a computer-readable storage medium in proximity to the computer 3000. Furthermore, a storage medium such as a hard disk or a RAM provided within a server system connected to a dedicated communication network or the Internet can be used as a computer-readable storage medium, to thereby provide the above-described program to the computer 3000 via the network.

While the embodiments of the present invention have been described, the technical scope of the invention is not limited to the above-described embodiments. It is apparent to those skilled in the art that various alterations and/or improvements can be added to the above-described embodiments. Also, to the extent not being technically inconsistent, matters explained about given embodiment can be applied to other embodiments. Moreover, each component may have features similar to those of other components which have the same name and have the different numerals. It is also apparent from the description of the scope of the claims that the embodiments added with such alterations or improvements can be included in the technical scope of the invention.

The actions, procedures, steps, and stages of each process performed by an apparatus, system, program, and method shown in the claims, embodiments, or drawings can be executed in any order as long as the order is not indicated by “prior to,” “before,” or the like and as long as the output from a previous process is not used in a later process. Even if the action flow is described using phrases such as “first” or “next” in the claims, embodiments, or drawings, it does not necessarily mean that the process must be performed in this order.

### EXPLANATION OF REFERENCES

10: communication network
20: owner
22: communication terminal
40: user
42: communication terminal
62: accident
64: accident
100: management system
110: management server
120: vehicle
122: vehicle
124: substitute vehicle
132: maintenance server
134: emergency lifesaving server
212: getting-on point
214: getting-off point
222: getting-on point
224: getting-off point
320: request reception section
330: vehicle management section
340: screen generation section
350: storage section
360: dispatch management section
370: payment management section
422: vehicle information storage section
424: owner information storage section
426: user information storage section
432: contract information storage section
434: dispatch plan storage section
436: payment information storage section
520: dispatch processing section
530: dispatch instruction section
540: substitute vehicle processing section
622: necessity determination section
624: change notification section
626: substitute vehicle arrangement section
628: consideration calculation section
700: screen
720: input reception section
730: input reception section
740: input reception section
752: icon
800: screen
820: input reception section
830: input reception section
840: input reception section
852: icon
900: screen
920: area
930: area
940: area
952: icon
954: icon
956: icon
1000: screen
1020: area
1030: area
1040: input reception section
1052: icon
1054: icon
3000: computer
3001: DVD-ROM
3010: host controller
3012: CPU
3014: RAM
3016: graphic controller
3018: display device
3020: input/output controller
3022: communication interface
3024: hard disk drive
3026: DVD-ROM drive
3030: ROM
3040: input/output chip
3042: keyboard

What is claimed is:

1. An information processing apparatus comprising:
a reservation information acquisition section configured to acquire reservation information indicating a reservation condition of a reservation of a first mobile object;
an arrival determination section configured to determine whether the first mobile object can arrive at a position indicated by the reservation information by a time indicated by the reservation information;
an arrangement section configured to determine to move a second mobile object different from the first mobile object to the position indicated by the reservation information in a case where it is determined that the first mobile object cannot arrive at the position indicated by the reservation information by the time indicated by the reservation information; and
a consideration determination section configured to determine a condition regarding a consideration for use of the second mobile object.

2. The information processing apparatus according to claim 1, wherein
the consideration determination section includes a consideration amount determination section configured to determine an amount of the consideration.

3. The information processing apparatus according to claim 2, wherein
the consideration amount determination section is configured to determine the amount of the consideration such that the amount of the consideration differs between a case where a user of the first mobile object indicated by the reservation information is an owner of the first mobile object or a person who uses the first mobile object for the owner and a case where a user of the first mobile object indicated by the reservation information is not the owner of the first mobile object or a person who uses the mobile object for the owner.

4. The information processing apparatus according to claim 2, wherein
the consideration determination section further includes a cause determination section configured to determine a cause for which the first mobile object cannot arrive at the position indicated by the reservation information by the time indicated by the reservation information, and
the consideration amount determination section is configured to determine the amount of the consideration on a basis of the cause determined by the cause determination section.

5. The information processing apparatus according to claim 3, wherein
the consideration determination section further includes a cause determination section configured to determine a cause for which the first mobile object cannot arrive at the position indicated by the reservation information by the time indicated by the reservation information, and
the consideration amount determination section is configured to determine the amount of the consideration on a basis of the cause determined by the cause determination section.

6. The information processing apparatus according to claim 4, wherein
in a case where a user of the first mobile object indicated by the reservation information is an owner of the first mobile object or a person who uses the first mobile object for the owner, the consideration amount determination section is configured to determine the amount of the consideration such that the amount of the consideration in a case where the cause is caused by the owner of the first mobile object or the person who uses the first mobile object for the owner is larger than the amount of the consideration in a case where the cause is not caused by the owner of the first mobile object or the person who uses the first mobile object for the owner.

7. The information processing apparatus according to claim 4, wherein
in a case where a user of the first mobile object indicated by the reservation information is an owner of the first mobile object or a person who uses the first mobile object for the owner, and the cause is not caused by the owner of the first mobile object or the person who uses the first mobile object for the owner, the consideration amount determination section is configured to determine the amount of the consideration for the use of the second mobile object such that the amount of the consideration for the use of the second mobile object is smaller than the amount of a consideration for use of the first mobile object.

8. The information processing apparatus according to claim 6, wherein
in a case where a user of the first mobile object indicated by the reservation information is an owner of the first mobile object or a person who uses the first mobile object for the owner, and the cause is not caused by the owner of the first mobile object or the person who uses the first mobile object for the owner, the consideration amount determination section is configured to determine the amount of the consideration for the use of the second mobile object such that the amount of the consideration for the use of the second mobile object is smaller than the amount of a consideration for use of the first mobile object.

9. The information processing apparatus according to claim 4, wherein
in a case where the cause is caused by a maintenance failure of the first mobile object, the cause determination section is configured to determine that the cause is caused by an owner of the first mobile object or a person who uses the first mobile object for the owner.

10. The information processing apparatus according to claim 6, wherein
in a case where the cause is caused by a maintenance failure of the first mobile object, the cause determination section is configured to determine that the cause is caused by an owner of the first mobile object or a person who uses the first mobile object for the owner.

11. The information processing apparatus according to claim 7, wherein
in a case where the cause is caused by a maintenance failure of the first mobile object, the cause determination section is configured to determine that the cause is caused by an owner of the first mobile object or a person who uses the first mobile object for the owner.

12. The information processing apparatus according to claim 7, further comprising:
a maintenance information acquisition section configured to acquire maintenance information indicating a maintenance status of the first mobile object, wherein
the cause determination section is configured to determine whether the cause is caused by a maintenance failure of the first mobile object on a basis of the maintenance information.

13. The information processing apparatus according to claim 4, wherein
the cause determination section is configured to determine that the cause is not caused by an owner of the first mobile object or a person who uses the first mobile object for the owner in a case where the cause is caused by an accident between the first mobile object and a third party and a percentage of negligence of the third party satisfies a predetermined condition or the cause is caused by a traffic situation.

14. The information processing apparatus according to claim 6, wherein
the cause determination section is configured to determine that the cause is not caused by an owner of the first mobile object or a person who uses the first mobile object for the owner in a case where the cause is caused by an accident between the first mobile object and a third party and a percentage of negligence of the third party satisfies a predetermined condition or the cause is caused by a traffic situation.

15. The information processing apparatus according to claim 7, wherein
the cause determination section is configured to determine that the cause is not caused by an owner of the first mobile object or a person who uses the first mobile object for the owner in a case where the cause is caused by an accident between the first mobile object and a third party and a percentage of negligence of the third party satisfies a predetermined condition or the cause is caused by a traffic situation.

16. The information processing apparatus according to claim 2, wherein
the consideration determination section further includes a payment method determination section configured to determine a payment method of the consideration.

17. The information processing apparatus according to claim 3, wherein
the consideration determination section further includes a payment method determination section configured to determine a payment method of the consideration.

18. A mobile object comprising the information processing apparatus according to claim 1.

19. A non-transitory computer-readable storage medium having recorded thereon a program that causes a computer to function as an information processing apparatus, wherein
the information processing apparatus comprises:
a reservation information acquisition section configured to acquire reservation information indicating a reservation condition of a reservation of a first mobile object;
an arrival determination section configured to determine whether the first mobile object can arrive at a position indicated by the reservation information by a time indicated by the reservation information;
an arrangement section configured to determine to move a second mobile object different from the first mobile object to the position indicated by the reservation information in a case where it is determined that the first mobile object cannot arrive at the position indicated by the reservation information by the time indicated by the reservation information; and
a consideration determination section configured to determine a condition regarding a consideration for use of the second mobile object.

20. A method comprising:
acquiring reservation information indicating a reservation condition of a reservation of a first mobile object;
determining whether the first mobile object can arrive at a position indicated by the reservation information by a time indicated by the reservation information;
determining to move a second mobile object different from the first mobile object to the position indicated by the reservation information in a case where it is determined that the first mobile object cannot arrive at the position indicated by the reservation information by the time indicated by the reservation information; and
determining a condition regarding a consideration for use of the second mobile object.
